(19) United States
(12) Patent Application Publication
(10) Pub. No.: US 2024/0400158 A1
(43) Pub. Date: Dec. 5, 2024

(54) ELECTRIC DEVICE OF HUMAN-POWERED VEHICLE

(71) Applicant: SHIMANO INC., Sakai City (JP)

(72) Inventors: Hiroaki GODA, Sakai City (JP); Toru SANO, Sakai City (JP); Takaaki FUJII, Sakai City (JP); Hiroki TANABE, Sakai City (JP)

(73) Assignee: SHIMANO INC., Sakai City (JP)

(21) Appl. No.: 18/328,785

(22) Filed: Jun. 5, 2023

(51) Int. Cl. B62M 9/122; B60L 50/20; B62J 43/20; B62M 6/45

(52) U.S. Cl. CPC B62M 9/122; B60L 50/20; B62J 43/20; B60L 2200/12; B60L 2210/12; B62J 43/30

(57) ABSTRACT

An electric device of a human-powered vehicle comprises an input part, an electric actuator, an actuator driver, and a converter circuit. The input part is configured to be electrically connected to an electric power source. The electric actuator is configured to move a movable member. The actuator driver is electrically connected to the electric actuator to control the electric actuator. The converter circuit is configured to convert a first voltage to a second voltage different from the first voltage. The converter circuit is electrically connected in series with the input part and the actuator driver.

### BACKGROUND

### Technical Field

The present invention relates to an electric device of a human-powered vehicle.

### Background Information

A human-powered vehicle includes an electric unit configured to be powered by an electric power supply. One of objects of the present disclosure is to improve the usability of the electric unit.

### SUMMARY

In accordance with a first aspect of the present invention, an electric device of a human-powered vehicle comprises an input part, an electric actuator, an actuator driver, and a converter circuit. The input part is configured to be electrically connected to an electric power source. The electric actuator is configured to move a movable member. The actuator driver is electrically connected to the electric actuator to control the electric actuator. The converter circuit is configured to convert a first voltage to a second voltage different from the first voltage. The converter circuit is electrically connected in series with the input part and the actuator driver.

With the electric device according to the first aspect, it is possible to adjust the first voltage to a voltage suitable for the actuator driver in a case where the first voltage is different from the voltage suitable for the actuator driver. Thus, it is possible to improve the usability of the electric device.

In accordance with a second aspect of the present invention, the electric device according to the first aspect is configured so that the converter circuit is configured to convert the first voltage to the second voltage which is lower than the first voltage.

With the electric device according to the second aspect, it is possible to adjust the first voltage to the voltage suitable for the actuator driver in a case where the first voltage is higher than the voltage suitable for the actuator driver.

In accordance with a third aspect of the present invention, the electric power source includes a first electric power source and a second electric power source. The input part is configured to be selectively electrically connected to each of the first electric power source and the second electric power source.

With the electric device according to the third aspect, it is possible to use the first electric power source and the second electric power source as the electric power source, improving reliably the usability of the electric device.

In accordance with a fourth aspect of the present invention, the electric device according to any one of the first to third aspects is configured so that the converter circuit is configured to convert the first voltage to the second voltage in a case where the input part is connected to the first electric power source.

With the electric device according to the fourth aspect, it is possible to adjust the first voltage supplied from the first electric power source to the voltage suitable for the actuator driver.

In accordance with a fifth aspect of the present invention, the electric device according to the fourth aspect is configured so that the converter circuit is configured to output the first voltage without converting the first voltage to the second voltage in a case where the input part is connected to the second electric power source.

With the electric device according to the fifth aspect, it is possible to supply, to the actuator driver, the first voltage supplied from the second electric power source in a case where the first voltage is suitable for the actuator driver.

In accordance with a sixth aspect of the present invention, the electric device according to any one of the first to fifth aspects is configured so that the converter circuit is configured to convert the first voltage to the second voltage in a case where an input voltage applied to the input part is higher than a first voltage threshold.

With the electric device according to the sixth aspect, it is possible to reliably adjust the first voltage to the voltage suitable for the actuator driver using the first voltage threshold.

In accordance with a seventh aspect of the present invention, the electric device according to the sixth aspect is configured so that the converter circuit is configured to output the first voltage without converting the first voltage to the second voltage in a case where the input voltage is lower than the first voltage threshold.

With the electric device according to the seventh aspect, it is possible to reliably supply the first voltage to the actuator driver in a case where the first voltage is suitable for the actuator driver.

In accordance with an eighth aspect of the present invention, the electric device according to the sixth or seventh aspect is configured so that the converter circuit is configured to convert the first voltage to the second voltage based on comparison of the input voltage with the first voltage threshold.

With the electric device according to the eighth aspect, it is possible to reliably make the first voltage suitable for the actuator driver based on the input voltage and the first voltage threshold.

In accordance with a ninth aspect of the present invention, the electric device according to any one of the first to eighth aspects is configured so that the converter circuit is configured to convert the first voltage to the second voltage in a case where the first voltage is higher than a second voltage threshold.

With the electric device according to the ninth aspect, it is possible to reliably make the first voltage suitable for the actuator driver based on the first voltage and the second voltage threshold.

In accordance with a tenth aspect of the present invention, the electric device according to the ninth aspect is configured so that the converter circuit is configured to output the first voltage without converting the first voltage to the second voltage in a case where the first voltage is lower than the second voltage threshold.

With the electric device according to the tenth aspect, it is possible to reliably supply the first voltage suitable for the actuator driver to the actuator driver based on the input voltage and the second voltage threshold.

In accordance with an eleventh aspect of the present invention, the electric device according to the ninth or tenth aspect is configured so that the converter circuit is configured to convert the first voltage to the second voltage based on comparison of the first voltage with the second voltage threshold.

With the electric device according to the eleventh aspect, it is possible to reliably supply the first voltage suitable for the actuator driver to the actuator driver based on the first voltage and the second voltage threshold.

In accordance with a twelfth aspect of the present invention, the electric device according to any one of the first to eleventh aspects further comprises a determination circuit configured to determine that the converter circuit converts the first voltage to the second voltage.

With the electric device according to the twelfth aspect, it is possible to improve the determination of whether the converter circuit converts the first voltage to the second voltage.

In accordance with a thirteenth aspect of the present invention, the electric device according to any one of the third to twelfth aspects is configured so that the input part is configured to be electrically connected to the first electric power source provided remotely from the electric device.

With the electric device according to the thirteenth aspect, it is possible to use the first electric power source provided remotely from the electric device.

In accordance with a fourteenth aspect of the present invention, the electric device according to any one of the third to thirteenth aspects is configured so that the input part is configured to be electrically connected to the first electric power source mounted to a vehicle body of the human-powered vehicle.

With the electric device according to the fourteenth aspect, it is possible to use the first electric power source mounted to the vehicle body.

In accordance with a fifteenth aspect of the present invention, the electric device according to any one of the third to fourteenth aspects is configured so that the input part is configured to be electrically connected to the second electric power source including a power generator configured to generate electricity.

With the electric device according to the fifteenth aspect, it is possible to use the power generator as the electric power source.

In accordance with a sixteenth aspect of the present invention, the electric device according to any one of the third to fifteenth aspects further comprises a mounting part to which the second electric power source is mounted.

With the electric device according to the sixteenth aspect, it is possible to mount the second electric power source via the mounting part, improving the usability of the electric device.

In accordance with a seventeenth aspect of the present invention, the electric device according to any one of the first to sixteenth aspects further comprises a housing includes an internal space. Each of the electric actuator and the converter circuit is at least partially provided in the internal space.

With the electric device according to the seventeenth aspect, the housing can protect the electric actuator and the converter circuit from foreign matters.

In accordance with an eighteenth aspect of the present invention, the electric device according to any one of the first to seventeenth aspects is configured so that the input part is provided closer to the converter circuit than the actuator driver.

With the electric device according to the eighteenth aspect, the arrangement enables the converter circuit to be electrically connected in series with the input part and the actuator driver.

In accordance with a nineteenth aspect of the present invention, the electric device according to any one of the first to eighteenth aspects further comprises an electronic controller electrically connected to the actuator driver to control the electric actuator via the actuator driver.

With the electric device according to the nineteenth aspect, the electronic controller enables the electric actuator to be controlled via the actuator driver.

In accordance with a twentieth aspect of the present invention, the electric device according to the nineteenth aspect further comprises an additional converter circuit configured to convert a third voltage to a fourth voltage. The additional converter circuit is electrically connected in series with the input part and the electronic controller.

With the electric device according to the twentieth aspect, it is possible to adjust the third voltage to a voltage suitable for another device using the additional converter circuit.

In accordance with a twenty-first aspect of the present invention, the electric device according to the nineteenth or twentieth aspect is configured so that the input part is provided closer to the converter circuit than the electronic controller.

With the electric device according to the twenty-first aspect, the arrangement enables the converter circuit to be electrically connected with the input part easily.

In accordance with a twenty-second aspect of the present invention, the electric device according to any one of the nineteenth to twenty-first aspects further comprises a circuit board. The input part, the converter circuit, and the electronic controller are provided on the circuit board.

With the electric device according to the twenty-second aspect, the circuit board can simplify the structures of the input part, the converter circuit, and the electronic controller.

In accordance with a twenty-third aspect of the present invention, the electric device according to any one of the first to twenty-second aspects further comprises an output part electrically connecting the electric actuator and the actuator driver to transmit a command from the actuator driver to the electric actuator.

With the electric device according to the twenty-third aspect, it is possible to reliably supply the first voltage or the second voltage to the electric actuator via the output part.

In accordance with a twenty-fourth aspect of the present invention, the electric device according to the twenty-third aspect further comprises a circuit board. The circuit board includes a first surface and a second surface provided on a reverse side of the first surface. The input part, the output part, and the converter circuit are provided on the first surface.

With the electric device according to the twenty-fourth aspect, the arrangement can reliably simplify the structures of the input part, the converter circuit, and the electronic controller.

In accordance with a twenty-fifth aspect of the present invention, the electric device according to any one of the first to twenty-fourth aspects further comprises a base member, a movable member, and a link member. The base member is mountable to the human-powered vehicle. The movable member is movable relative to the base member. The link member movably couples the base member and the movable member.

With the electric device according to the twenty-fifth aspect, it is possible to apply the structure of the electric device to a device including the base member, the movable member, and the link member.

In accordance with a twenty-sixth aspect of the present invention, the electric device according to the twenty-fifth aspect is configured so that the converter circuit is at least partially provided to at least one of the base member, the movable member, and the link member.

With the electric device according to the twenty-sixth aspect, it is possible to improve the flexibility in arranging the converter circuit.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a side elevational view of a human-powered vehicle including an electric device in accordance with one of embodiments.

FIG. 2 is a schematic block diagram of the human-powered vehicle illustrated in FIG. 1.

FIG. 3 is a side elevational view of the electric device illustrated in FIG. 2.

FIG. 4 is a rear view of the electric device illustrated in FIG. 2.

FIG. 5 is a cross-sectional view of the electric device taken along line V-V of FIG. 4.

FIG. 6 is a top view of a bicycle derailleur illustrated in accordance with a modification.

FIG. 7 is a schematic block diagram of the electric device illustrated in FIG. 1.

FIG. 8 is a schematic block diagram of the electric device illustrated in FIG. 1.

FIG. 9 is a cross-sectional view of the electric device taken along line IX-IX of FIG. 5.

FIG. 10 is a cross-sectional view of the electric device taken along line X-X of FIG. 5.

FIG. 11 is a schematic block diagram of a human-powered vehicle in accordance with a modification.

FIG. 12 is a schematic block diagram of a human-powered vehicle in accordance with a modification.

FIG. 13 is a schematic block diagram of an electric device in accordance with a first modification.

FIG. 14 is a plan view showing an arrangement of electronic parts of the electric device in accordance with the first modification.

FIG. 15 is a plan view showing an arrangement of electronic parts of an electric device in accordance with a second modification.

FIG. 16 is a schematic block diagram of a human-powered vehicle in accordance with a modification.

### DESCRIPTION OF THE EMBODIMENTS

The embodiments will now be described with reference to the accompanying drawings, wherein like reference numerals designate corresponding or identical elements throughout the various drawings.

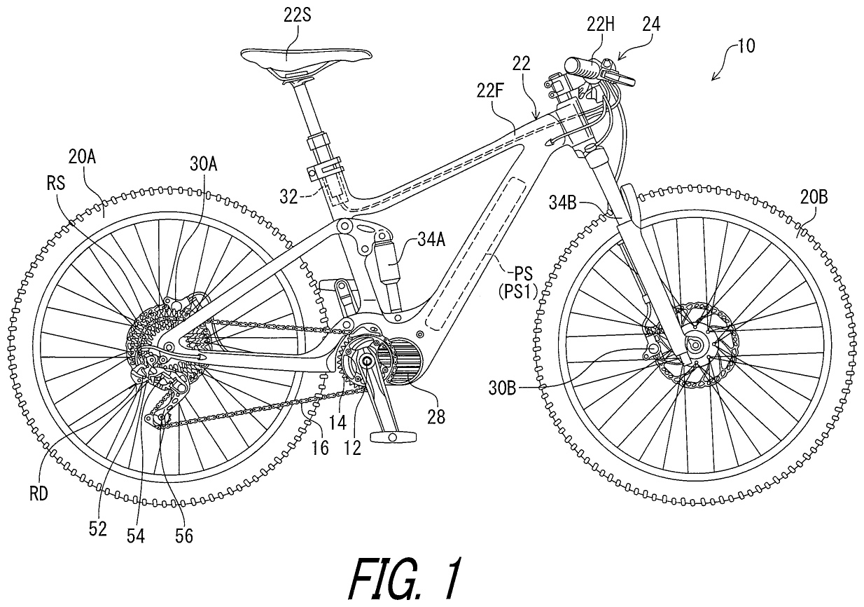

As seen in FIG. 1, a human-powered vehicle 10 includes a crank 12, a sprocket 14, a chain 16, a sprocket assembly RS, a wheel 20A, a wheel 20B, and a vehicle body 22. The vehicle body 22 includes, for example, a frame 22F, a handlebar 22H, and a saddle 22S. The crank 12 is rotatably coupled to the vehicle body 22. The crank 12 is rotatable relative to the vehicle body 22 during pedaling. The sprocket 14 is coupled to the crank 12. The sprocket assembly RS is rotatably coupled to the vehicle body 22. The chain 16 is engaged with the sprocket 14 and the sprocket assembly RS. The sprocket assembly RS is coupled to the wheel 20A to transmit a pedaling force from the crank 12 to the wheel 20A via the sprocket 14 and the chain 16. The sprocket 14 can include at least two sprockets if needed or desired.

The human-powered vehicle 10 includes an operating device 24. The human-powered vehicle 10 includes electric devices RD, 28, 30A, 30B, 32, 34A, and 34B. The electric device RD can also be referred to as a derailleur RD. The electric device 28 can also be referred to as a drive unit 28. The electric device 30A can also be referred to as a brake device 30A. The electric device 30B can also be referred to as a brake device 30B. The electric device 32 can also be referred to as an adjustable seatpost 32. The electric device 34A can also be referred to as a suspension 34A. The electric device 34B can also be referred to as a suspension 34B. The human-powered vehicle 10 can include another electric device other than the electric devices RD, 28, 30A, 30B, 32, 34A, and 34B if needed or desired. At least one of the electric devices RD, 28, 30A, 30B, 32, 34A, and 34B can be omitted from the human-powered vehicle 10 if needed or desired.

The human-powered vehicle 10 includes an electric power source PS. The electric power source PS includes a first electric power source PS1. The first electric power source PS1 is configured to supply electricity to at least one of the operating device 24 and the electric devices RD, 28, 30A, 30B, 32, 34A, and 34B. For example, the first electric power source PS1 includes a battery and a battery holder. Examples of the battery include a primary battery and a secondary battery. The battery holder is configured to detachably and reattachably hold the battery. The first electric power source PS1 is at least partially provided in the vehicle body 22. However, the first electric power source PS1 can be entirely provided outside the vehicle body 22 if needed or desired. The first electric power source PS1 can be at least partially provided in a tubular part such as a seat tube or a down tube if needed or desired. The first electric power source PS1 can include a power generator configured to generate electricity if needed or desired. The first electric power source PS1 can be configured to supply electricity to at least one of the operating device 24 and the electric devices RD, 28, 30A, 30B, 32, 34A, and 34B via another of the operating device 24 and the electric devices RD, 28, 30A, 30B, 32, 34A, and 34B if needed or desired. For example, the first electric power source PS1 can be configured to supply electricity to at least one of the operating device 24 and the electric devices RD, 30A, 30B, 32, 34A, and 34B via the electric device 28. In such embodiments, the electricity can be converted from an output voltage of the first electric power source PS1 to a voltage different from the output voltage by the electric device 28.

The operating device 24 is configured to receive a user input and is mounted to the handlebar 22H. The operating device 24 is configured to operate at least one of the electric devices RD, 28, 30A, 30B, 32, 34A, and 34B in response to the user input. The operating device 24 can be mounted to parts other than the handlebar 22H if needed or desired.

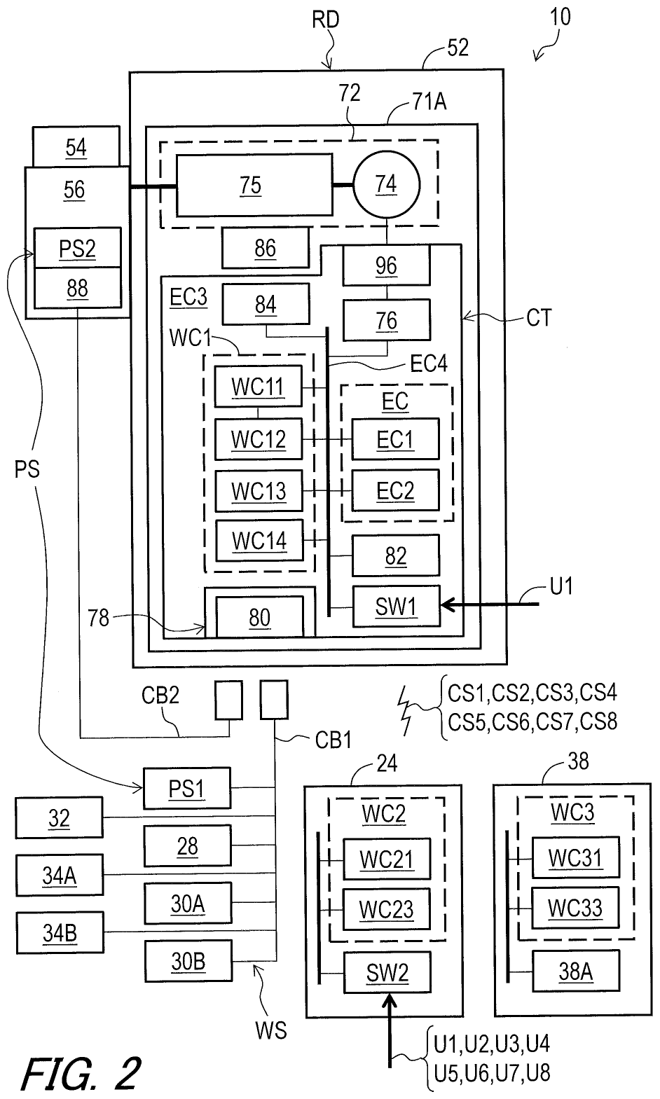

As seen in FIG. 2, the operating device 24 is configured to generate a control signal to control at least one of the electric devices RD, 28, 30A, 30B, 32, 34A, and 34B. The operating device 24 includes at least one of a button, a dial, and a lever. The operating device 24 can includes an electric power source such as a battery. The operating device 24 can include a single operating device or at least two separate operating devices.

The operating device 24 is configured to generate a control signal CS1 in response to a user input U1. The operating device 24 is configured to generate a control signal CS2 in response to a user input U2. The operating device 24 is configured to generate a control signal CS3 in response to a user input U3. The operating device 24 is configured to generate a control signal CS4 in response to a user input U4. The operating device 24 is configured to generate a control signal CS5 in response to a user input U5. The operating device 24 is configured to generate a control signal CS6 in response to a user input U6. The operating device 24 is configured to generate a control signal CS7 in response to a user input U7. The operating device 24 is configured to generate a control signal CS8 in response to a user input U8.

The electric device RD is configured to change a gear ratio of the human-powered vehicle 10. The gear ratio is a ratio of a rotational speed of the sprocket assembly RS to a rotational speed of the sprocket 14. The electric device RD is configured to change the gear ratio in response to the control signal CS1 or CS2 generated by the operating device 24. For example, the control signal CS1 indicates one of upshifting and downshifting of the electric device RD. The control signal CS2 indicates the other of upshifting and downshifting of the electric device RD.

The electric device 28 is configured to assist propulsion of the human-powered vehicle 10. The electric device 28 is mountable to the vehicle body 22. The electric device 28 is configured to generate an assist driving force using electricity supplied from the first electric power source PS1. The electric device 28 is configured to change an assist ratio depending on a human power applied to the human-powered vehicle 10. The electric device 28 includes an electric actuator configured to generate the assist driving force. Examples of the electric actuator includes an electric motor. The electric device 28 is configured to change the assist ratio which is a ratio of the assist driving force to the human power applied to the human-powered vehicle 10 in response to the control signal CS3 generated by the operating device 24.

The electric device 30A is configured to apply a braking force to the human-powered vehicle 10. The electric device 30A is mountable to the vehicle body 22. The electric device 30A is configured to apply a braking force to the wheel 20A. The electric device 30A includes an electric brake device configured to generate the braking force using electricity supplied from the first electric power source PS1. The electric device 30A includes an electric actuator configured to generate the braking force. Examples of the electric actuator includes an electric motor. The electric actuator of the electric device 30A is configured to change the braking force in response to the control signal CS4 generated by the operating device 24.

The electric device 30B is configured to apply a braking force to the human-powered vehicle 10. The electric device 30B is mountable to the vehicle body 22. The electric device 30B is configured to apply a braking force to the wheel 20B. The electric device 30B includes an electric brake device configured to generate the braking force using electricity supplied from the first electric power source PS1. The electric device 30B includes an electric actuator configured to generate the braking force. Examples of the electric actuator includes an electric motor. The electric actuator of the electric device 30B is configured to change the braking force in response to the control signal CS5 generated by the operating device 24.

The electric device 32 is configured to change a height of the saddle 22S relative to the frame 22F. The electric device 32 is mountable to the human-powered vehicle 10. The electric device 32 includes an electric adjustable seatpost. The electric device 32 includes an electric actuator configured to generate a force to change the height of the saddle 22S using electricity supplied from the first electric power source PS1. Examples of the electric actuator include an electric motor. The electric device 32 is configured to change the height of the saddle 22S relative to the frame 22F in response to the control signal CS6 generated by the operating device 24. The electric device 32 has an adjustable state and a locked state. The electric device 32 allows the user to change the height of the saddle 22S in the adjustable state. The electric device 32 is locked to maintain the height of the saddle 22S in the locked state. The electric device 32 is configured to change the state of the electric device 32 between the adjustable state and the locked state in response to the control signal CS6 generated by the operating device 24.

The electric device 34A is configured to absorb shocks and vibrations generated by riding on rough terrain. The electric device 34A is coupled to the vehicle body 22. The electric device 34A can include a spring suspension, a hydraulic suspension, and an air suspension. The electric device 34A includes an electric suspension. The electric device 34A includes an electric actuator configured to generate a force to change a state of the electric device 34A using electricity supplied from the first electric power source PS1. Examples of the electric actuator include an electric motor. Examples of the state of the electric device 34A include a long-stroke state, a short-stroke state, an absorption state, and a locked state. The electric device 34A is configured to change the state using the force in response to the control signal CS7 generated by the operating device 24.

The electric device 34B is configured to absorb shocks and vibrations generated by riding on rough terrain. The electric device 34B is coupled to the vehicle body 22. The electric device 34B can include a spring suspension, a hydraulic suspension, and an air suspension. The electric device 34B includes an electric suspension. The electric device 34B includes an electric actuator configured to generate a force to change a state of the electric device 34B using electricity supplied from the first electric power source PS1. Examples of the electric actuator include an electric motor. Examples of the state of the electric device 34B include a long-stroke state, a short-stroke state, an absorption state, and a locked state. The electric device 34B is configured to change the state using the force in response to the control signal CS8 generated by the operating device 24.

The human-powered vehicle 10 includes a display device 38. The display device 38 is configured to display information relating to the human-powered vehicle 10. The display device 38 is coupled to the vehicle body 22. For example, the display device 38 is coupled to the handlebar 22H. The display device 38 is configured to receive the information relating to the human-powered vehicle 10 from a component of the human-powered vehicle 10. The display device 38 can be detachably coupled to the vehicle body 22 if needed or desired. The display device 38 can include at least one of a smartphone, a cyclocomputer, and a tablet computer.

In the present application, the term “human-powered vehicle” includes a vehicle to travel with a motive power including at least a human power of a user who rides the vehicle. The human-powered vehicle includes a various kind of bicycles such as a mountain bike, a road bike, a city bike, a cargo bike, a hand bike, and a recumbent bike. Furthermore, the human-powered vehicle includes an electric bike called as an E-bike. The electric bike includes an electrically assisted bicycle configured to assist propulsion of a vehicle with an electric motor. However, a total number of wheels of the human-powered vehicle is not limited to two. For example, the human-powered vehicle includes a vehicle having one wheel or three or more wheels. Especially, the human-powered vehicle does not include a vehicle that uses only a driving source as motive power. Examples of the driving source include an internal-combustion engine and an electric motor. Generally, a light road vehicle, which includes a vehicle that does not require a driver's license for a public road, is assumed as the human-powered vehicle.

In the present application, the following directional terms “front,” “rear,” “forward,” “rearward,” “left,” “right,” “transverse,” “upward” and “downward” as well as any other similar directional terms refer to those directions which are determined on the basis of the user who is in the user's standard position in the human-powered vehicle 10 with facing a handlebar or steering. Examples of the user's standard position include a saddle and a seat. Accordingly, these terms, as utilized to describe the electric devices RD, 28, 30A, 30B, 32, 34A, and 34B or other devices, should be interpreted relative to the human-powered vehicle 10 equipped with the electric devices RD, 28, 30A, 30B, 32, 34A, and 34B or other devices as used in an upright riding position on a horizontal surface.

In the present embodiment, the electric device RD will be described in detail. The structure of the electric device RD can be applied to each of the electric devices 28, 30A, 30B, 32, 34A, and 34B or other electric devices if needed or desired.

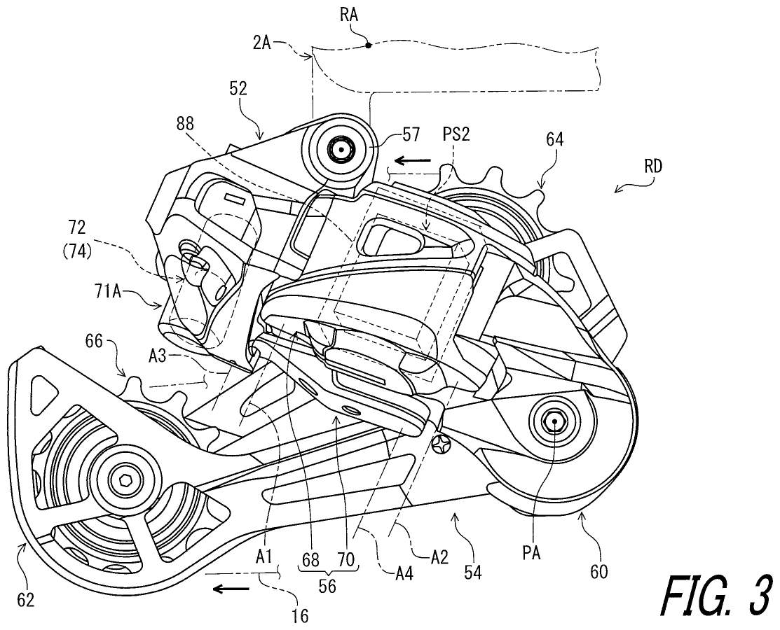

As seen in FIG. 3, the electric device RD further comprises a base member 52, a movable member 54, and a link member 56. The base member 52 is mountable to the human-powered vehicle 10. The base member 52 is mountable to the vehicle body 22 of the human-powered vehicle 10. The base member 52 is configured to be coupled to the vehicle body 22 with a derailleur fastener 57. The movable member 54 is movable relative to the base member 52. The link member 56 movably couples the base member 52 and the movable member 54.

The movable member 54 includes a coupling member 60, a guide plate 62, a guide pulley 64, and a tension pulley 66. The guide plate 62 is pivotally coupled to the coupling member 60 about a pivot axis PA. The guide pulley 64 is rotatably coupled to the guide plate 62. The tension pulley 66 is rotatably coupled to the guide plate 62. The guide pulley 64 is configured to be engaged with the chain 16. The tension pulley 66 is configured to be engaged with the chain 16. The structure of the movable member 54 is not limited to the above structure. For example, the coupling member 60 can be omitted from the movable member 54 if needed or desired.

The link member 56 movably couples the base member 52 and the coupling member 60. In the present embodiment, the link member 56 includes a first link 68 and a second link 70. The first link 68 is pivotally coupled to the base member 52 about a first pivot axis A1. The first link 68 is pivotally coupled to the movable member 54 about a second pivot axis A2. The second link 70 is pivotally coupled to the base member 52 about a third pivot axis A3. The second link 70 is pivotally coupled to the movable member 54 about a fourth pivot axis A4. The first to fourth pivot axes A1 to A4 are parallel to each other. However, one of the first link 68 and the second link 70 can be omitted from the link member 56 if needed or desired. The structure of the link member 56 is not limited to the above structure. At least one of the first to fourth pivot axes A1 to A4 can be non-parallel to another of the first to fourth pivot axes A1 to A4.

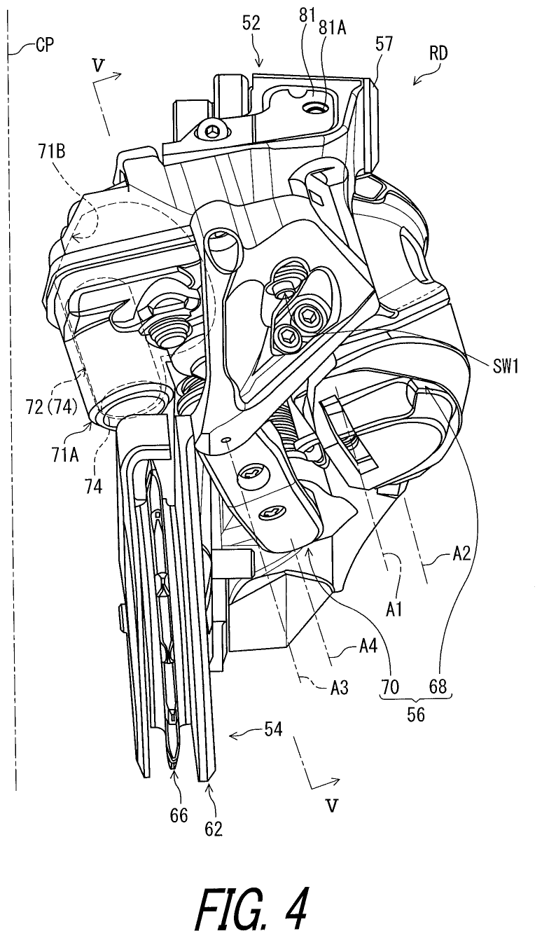

As seen in FIG. 4, the second link 70 is at least partially provided between the first link 68 and a transverse center plane CP of the human-powered vehicle 10. The transverse center plane CP is defined to be perpendicular to a sprocket rotational axis RA (see e.g., FIG. 3) of the sprocket assembly RS (see e.g., FIG. 1).

The electric device RD of the human-powered vehicle 10 comprises an electric actuator 72. In the present embodiment, the electric actuator 72 includes an electric motor 74. The electric actuator 72 is configured to generate a driving force. The driving force includes a driving rotational force. In the present application, the term “rotational force” can also be referred to as “torque” or “moment.” The electric actuator 72 is configured to generate the driving rotational force. The electric actuator 72 is configured to generate the driving rotational force to actuate an actuated device of the human-powered vehicle 10. In the present embodiment, the electric actuator 72 is configured to generate the driving rotational force to move the movable member 54 relative to the base member 52. However, the electric actuator 72 can be configured to actuate another device other than the electric device RD if needed or desired.

The electric actuator 72 is at least partially provided to at least one of the base member 52, the movable member 54, and the link member 56. In the present embodiment, the electric actuator 72 is provided to the base member 52. However, the electric actuator 72 can be provided to at least one of the base member 52, the movable member 54, and the link member 56 if needed or desired.

The electric actuator 72 is configured to apply the driving force to the movable member 54. The electric actuator 72 is configured to move at least one of the movable member 54 and the link member 56 relative to the base member 52. In the present embodiment, the electric actuator 72 is configured to move the movable member 54 relative to the base member 52. The electric actuator 72 is coupled to the link member 56 to move the movable member 54 via the link member 56. However, the electric actuator 72 can be directly coupled to the movable member 54 to move the movable member 54 relative to the base member 52 if needed or desired.

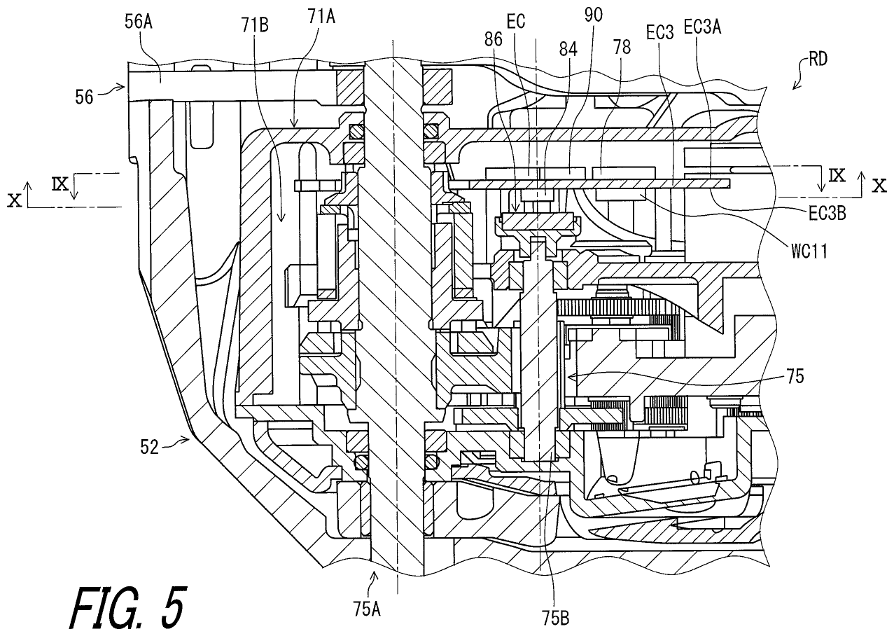

As seen in FIG. 5, the electric device RD includes a transmitting structure 75. The transmitting structure 75 is configured to transmit the driving force from the electric actuator 72 (see e.g., FIG. 2) to the link member 56. The transmitting structure 75 at least one gear, an output shaft 75A, and a rotational shaft 75B. The link member 56 includes a coupling link 56A. The coupling link 56A is coupled to the output shaft 75A to rotate along with the output shaft 75A. The output shaft 75A is coupled to the link member 56 via the coupling link 56A. The rotational shaft 75B is provided between the electric actuator 72 (see e.g., FIG. 2) and the output shaft 75A in a transmission path. The rotational shaft 75B is rotatable in response to the driving force generated by the electric actuator 72 (see e.g., FIG. 2).

The electric device RD further comprises a housing 71A. The housing 71A includes an internal space 71B. The transmitting structure 75 is at least partially provided in the internal space 71B. In the present embodiment, the transmitting structure 75 is partially provided in the internal space 71B. The output shaft 75A is at least partially provided in the internal space 71B. In the present embodiment, the output shaft 75A is partially provided in the internal space 71B. The rotational shaft 75B is entirely provided in the internal space 71B. However, the transmitting structure 75 can be entirely provided in the internal space 71B if needed or desired.

The housing 71A is a separate member from the base member 52, the movable member 54, and the link member 56. The housing 71A is secured to the base member 52. However, the housing 71A can be integrally provided with at least one of the base member 52, the movable member 54, and the link member 56 if needed or desired. The housing 71A can be secured to at least one of the base member 52, the movable member 54, and the link member 56 if needed or desired.

As seen in FIG. 4, the electric actuator 72 is at least partially provided in the internal space 71B. The electric motor 74 is at least partially provided in the internal space 71B. In the present embodiment, the electric actuator 72 is entirely provided in the internal space 71B. The electric motor 74 is entirely provided in the internal space 71B. However, the electric actuator 72 can be partially provided in the internal space 71B if needed or desired. The electric motor 74 can be partially provided in the internal space 71B if needed or desired.

As seen in FIG. 2, the electric device RD comprises electric circuitry CT. The electric circuitry CT is electrically connected to the electric actuator 72 to control the electric actuator 72. The electric circuitry CT is electrically connected to the electric motor 74 to control the electric motor 74. The electric circuitry CT includes an actuator driver 76. Namely, the electric device RD of the human-powered vehicle 10 comprises the actuator driver 76. The actuator driver 76 is electrically connected to the electric actuator 72 to control the electric actuator 72. The actuator driver 76 includes a circuit configured to control the electric actuator 72 to move the movable member 54 based on a control signal.

The electric circuitry CT includes an electronic controller EC, a circuit board EC3, and a system bus EC4. Namely, the electric device RD further comprises the electronic controller EC. The electric device RD further comprises a circuit board EC3. The electronic controller EC is electrically mounted on the circuit board EC3. The actuator driver 76 is electrically mounted on the circuit board EC3. The system bus EC4 is electrically mounted on the circuit board EC3. The electronic controller EC is electrically connected to the actuator driver 76 via the circuit board EC3 and the system bus EC4. The electronic controller EC is electrically connected to the actuator driver 76 to control the electric actuator 72 via the actuator driver 76. Examples of the circuit board EC3 include a printed circuit board and a flexible printed circuit. The circuit board EC3 can also be referred to as a substrate EC3.

The actuator driver 76 can be electrically mounted on another circuit board EC3 in a case where the electric circuitry CT includes at least two circuit boards. Furthermore, the actuator driver 76 does not need to be electrically mounted on a circuit board.

The electronic controller EC is electrically connected to the electric actuator 72 to control the electric actuator 72 based on control information. The electronic controller EC is electrically connected to the actuator driver 76 to control the electric actuator 72 via the actuator driver 76 based on the control information. For example, the control information includes the control signal CS1 or CS2 transmitted from the operating device 24. The electronic controller EC is configured to control the electric actuator 72 to move the movable member 54 based on the control signal CS1 or CS2 transmitted from the operating device 24.

The electronic controller EC includes a hardware processor EC1 and a hardware memory EC2. The hardware processor EC1 is coupled to the hardware memory EC2. The hardware memory EC2 is coupled to the hardware processor EC1. The hardware processor EC1 and the hardware memory EC2 are electrically mounted on the circuit board EC3. The hardware processor EC1 is electrically connected to the hardware memory EC2 via the circuit board EC3 and the system bus EC4. The hardware memory EC2 is electrically connected to the hardware processor EC1 via the circuit board EC3 and the system bus EC4. For example, the electronic controller EC includes a semiconductor. The hardware processor EC1 includes a semiconductor. The hardware memory EC2 includes a semiconductor. However, the electronic controller EC can be free of a semiconductor if needed or desired. The hardware processor EC1 can be free of a semiconductor if needed or desired. The hardware memory EC2 can be free of a semiconductor if needed or desired.

For example, the hardware processor EC1 includes at least one of a central processing unit (CPU), a micro processing unit (MPU), and a memory controller. The hardware memory EC2 is electrically connected to the hardware processor EC1. For example, the hardware memory EC2 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The hardware memory EC2 includes storage areas each having an address. The hardware processor EC1 is configured to control the hardware memory EC2 to store data in the storage areas of the hardware memory EC2 and reads data from the storage areas of the hardware memory EC2. The hardware memory EC2 can also be referred to as a computer-readable storage medium EC2.

The electronic controller EC is configured to execute at least one control algorithm of the electric device RD. For example, the electronic controller EC is programed to execute at least one control algorithm of the electric device RD. The hardware memory EC2 stores at least one program including at least one program instruction. The at least one program is read into the hardware processor EC1, and thereby the at least one control algorithm of the electric device RD is executed based on the at least one program. The electronic controller EC can also be referred to as an electronic controller circuit or circuitry EC. The electronic controller EC can also be referred to as an electronic hardware controller circuit or circuitry EC.

The structure of the electric circuitry CT is not limited to the above structure. The structure of the electronic controller EC is not limited to the above structure. The structure of the electronic controller EC is not limited to the hardware processor EC1 and the hardware memory EC2. The electric circuitry CT can be realized by hardware alone or a combination of hardware and software. In the present embodiment, the hardware processor EC1 and the hardware memory EC2 are integrated as a single chip such as an application specific integrated circuit (ASIC) or a field programmable gate array (FPGA). However, the hardware processor EC1 and the hardware memory EC2 can be separate chips if needed or desired. The electronic controller EC can include the hardware processor EC1, the hardware memory EC2, the circuit board EC3, and the system bus EC4 if needed or desired. The electronic controller EC can be at least two electronic controllers which are separately provided. The electric circuitry CT can include at least two electronic controllers which are separately provided. The at least one control algorithm of the electric device RD can be executed by the at least two electronic controllers if needed or desired. The electronic controller EC can include at least two hardware processors which are separately provided. The electronic controller EC can include at least two hardware memories which are separately provided. The at least one control algorithm of the electric device RD can be executed by the at least two hardware processors if needed or desired. The at least one control algorithm of the electric device RD can be stored in the at least two hardware memories if needed or desired. The electric circuitry CT can include at least two circuit boards which are separately provided if needed or desired. The electric circuitry CT can include at least two system buses which are separately provided if needed or desired.

As seen in FIG. 2, the electric device RD of the human-powered vehicle 10 comprises a communicator WC1. The communicator WC1 is configured to communicate with an additional communicator. Examples of the additional communicator include a communicator of the operating device 24. In the present embodiment, the operating device 24 includes an additional communicator WC2. The display device 38 includes an additional communicator WC3. The communicator WC1 is configured to receive a signal from the additional communicator WC2. The communicator WC1 is configured to transmit a signal to the additional communicator WC3. The electronic controller EC is electrically connected to the communicator WC1. For example, the communicator WC1 is electrically mounted on the circuit board EC3. However, the communicator WC1 can be electrically mounted on another circuit board in a case where the electric circuitry CT includes at least two circuit boards. The communicator WC1 does not need to be electrically mounted on a circuit board.

In the present embodiment, the communicator WC1 includes a first wireless communicator WC11 and an antenna WC12. The first wireless communicator WC11 is electrically connected to the antenna WC12. The first wireless communicator WC11 is configured to wirelessly communicate with the additional communicator via the antenna WC12. The first wireless communicator WC11 is configured to wirelessly receive a signal from the additional communicator. The electronic controller EC is electrically connected to the first wireless communicator WC11 to receive signals wirelessly received by the first wireless communicator WC11 via the antenna WC12. The electronic controller EC is electrically connected to the first wireless communicator WC11 to transmit signals via the first wireless communicator WC11 and the antenna WC12.

The first wireless communicator WC11 is electrically mounted on the circuit board EC3. The first wireless communicator WC11 is electrically connected to the hardware processor EC1 and the hardware memory EC2 with the circuit board EC3 and the system bus EC4. The first wireless communicator WC11 includes at least one of a signal transmitting circuit or circuitry and a signal receiving circuit or circuitry.

The first wireless communicator WC11 is configured to superimpose digital signals on carrier wave using a predetermined wireless communication protocol to wirelessly transmit signals. The first wireless communicator WC11 is configured to encrypt signals using a cryptographic key to generate encrypted wireless signals. The first wireless communicator WC11 is configured to transmit wireless signals via the antenna WC12.

The first wireless communicator WC11 is configured to receive wireless signals via antenna WC12. In the present embodiment, the first wireless communicator WC11 is configured to decode the wireless signals to recognize signals transmitted from other wireless communicators. The first wireless communicator WC11 is configured to decrypt the wireless signals using the cryptographic key.

The communicator WC1 includes a second wireless communicator WC14. In the present embodiment, the second wireless communicator WC14 includes an antenna and is integrally provided with the antenna as a single chip. However, the communicator WC1 can includes an additional antenna electrically connected to the second wireless communicator WC14 if needed or desired.

The second wireless communicator WC14 is configured to wirelessly communicate with the additional communicator via the antenna. The second wireless communicator WC14 is configured to wirelessly receive a signal from the additional communicator. The electronic controller EC is electrically connected to the second wireless communicator WC14 to receive signals wirelessly received by the second wireless communicator WC14 via the antenna. The electronic controller EC is electrically connected to the second wireless communicator WC14 to transmit signals via the second wireless communicator WC14 and the antenna.

The second wireless communicator WC14 is electrically mounted on the circuit board EC3. The second wireless communicator WC14 is electrically connected to the hardware processor EC1 and the hardware memory EC2 with the circuit board EC3 and the system bus EC4. The second wireless communicator WC14 includes at least one of a signal transmitting circuit or circuitry and a signal receiving circuit or circuitry.

The second wireless communicator WC14 is configured to superimpose digital signals on carrier wave using a predetermined wireless communication protocol to wirelessly transmit signals. The second wireless communicator WC14 is configured to encrypt signals using a cryptographic key to generate encrypted wireless signals. The second wireless communicator WC14 is configured to transmit wireless signals via the antenna.

The second wireless communicator WC14 is configured to receive wireless signals via antenna. In the present embodiment, the second wireless communicator WC14 is configured to decode the wireless signals to recognize signals transmitted from other wireless communicators. The second wireless communicator WC14 is configured to decrypt the wireless signals using the cryptographic key.

The term “wireless communicator” as used herein includes a receiver, a transmitter, a transceiver, a transmitter-receiver, and contemplates any device or devices, separate or combined, capable of transmitting and/or receiving wireless communication signals, including shift signals or control, command or other signals related to some function of the component being controlled. Here, the first wireless communicator WC11 is configured to at least receive a wireless signal. The second wireless communicator WC14 is configured to at least receive a wireless signal. For example, the first wireless communicator WC11 is a two-way wireless transceiver that conducts two-way wireless communications using the wireless receiver for wirelessly receiving shift signals and a wireless transmitter for wirelessly transmitting data. In the present embodiment, the first wireless communicator WC11 can wirelessly communicate with at least one of the operating device 24 and the electric devices RD, 28, 30A, 30B, 32, 34A, and 34B. The second wireless communicator WC14 can wirelessly communicate with at least one of the operating device 24 and the electric devices RD, 28, 30A, 30B, 32, 34A, and 34B. The wireless control signals of each of the first wireless communicator WC11 and the second wireless communicator WC14 can be radio frequency (RF) signals, ultra-wide band communication signals, radio frequency identification (RFID), Wi-Fi (registered trademark), Zigbee (registered trademark), ANT+ (registered trademark) communications, or Bluetooth (registered trademark) communications or any other type of signal suitable for short range wireless communications as understood in the bicycle field. It should also be understood that each of the first wireless communicator WC11 and the second wireless communicator WC14 can transmit the signals at a particular frequency and/or with an identifier such as a particular code, to distinguish the wireless control signal from other wireless control signals. In this way, the electric device RD can recognize which control signals are to be acted upon and which control signals are not to be acted upon. Thus, the electric device RD can ignore the control signals from other wireless communicators of other electric devices. The communication protocol of the first wireless communicator WC11 is different from the communication protocol of the second wireless communicator WC14. One of the first wireless communicator WC11 and the second wireless communicator WC14 can be omitted from the communicator WC1 if needed or desired. In such modifications, one of the first wireless communicator WC11 and the second wireless communicator WC14 can be configured to wirelessly communicate with both the additional communicators WC2 and WC3. Furthermore, the first wireless communicator WC11 and the second wireless communicator WC14 can be integrally provided as a single chip if needed or desired.

The operating device 24 includes a user interface SW2 configured to receive at least one user input. Examples of the user interface SW2 includes an electric switch. In the present embodiment, the user interface SW2 is configured to receive user inputs U21 and U22. The additional communicator WC2 is configured to wirelessly transmit the control signal CS1 in response to the user input U21 received by the user interface SW2. The additional communicator WC2 is configured to wirelessly transmit the control signal CS2 in response to the user input U22 received by the user interface SW2.

The additional communicator WC2 has substantially the same structure as the structure of the communicator WC1. The additional communicator WC2 includes an additional wireless communicator WC21 and an additional antenna WC23. The user interface SW2 is electrically connected to the additional wireless communicator WC21. In the present embodiment, the additional wireless communicator WC21 is configured to wirelessly communicate with the first wireless communicator WC11 of the electric device RD via the additional antenna WC23. The additional wireless communicator WC21 has substantially the same structure as the structure of at least one of the first wireless communicator WC11 and the second wireless communicator WC14. The additional antenna WC23 has substantially the same structure as the structure of the antenna WC12. Thus, they will not be described in detail here for the sake of brevity.

The display device 38 includes a display 38A. The display 38A is configured to display information relating to the human-powered vehicle 10. The additional communicator WC3 is configured to wirelessly communicate with the communicator WC1 of the electric device RD.

The additional communicator WC3 has substantially the same structure as the structure of the communicator WC1. The additional communicator WC3 includes an additional wireless communicator WC31 and an additional antenna WC33. The display 38A is electrically connected to the additional wireless communicator WC31. In the present embodiment, the additional wireless communicator WC31 is configured to wirelessly communicate with the second wireless communicator WC14 of the electric device RD via the additional antenna WC33. The additional wireless communicator WC31 has substantially the same structure as the structure of at least one of the first wireless communicator WC11 and the second wireless communicator WC14. The additional antenna WC33 has substantially the same structure as the structure of the antenna WC12. Thus, they will not be described in detail here for the sake of brevity.

As seen in FIG. 2, the communicator WC1 includes a filter circuit WC13. The electric device RD of the human-powered vehicle 10 comprises an input part 78. The input part 78 is electrically connected to the filter circuit WC13. The input part 78 includes a connector port 80 to which a connector of an electric cable is detachably and reattachably connected. For example, the connector port 80 is configured to be connected to a connector of an electric cable CB1 electrically connected to the first electric power source PS1. The filter circuit WC13 is electrically connected to the electronic controller EC, the first wireless communicator WC11, the electric actuator 72, and the connector port 80. The filter circuit WC13 is configured to receive electricity from the first electric power source PS1 via the connector port 80.

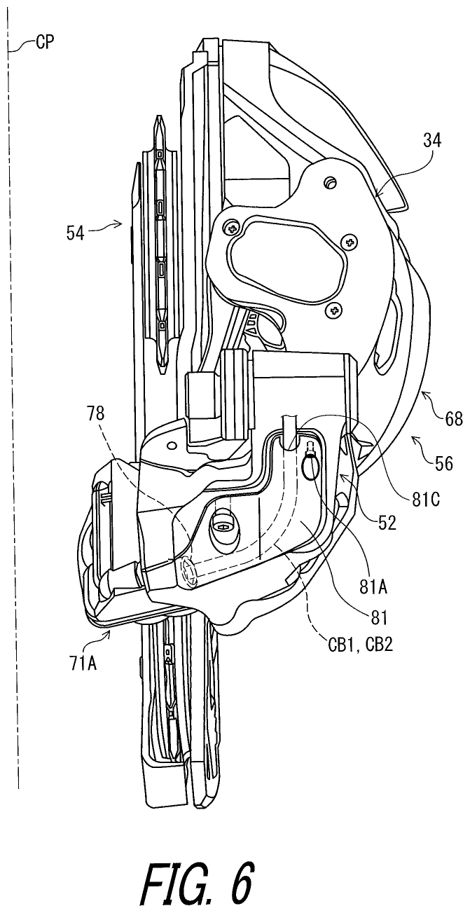

As seen in FIG. 6, the electric device RD includes a cover 81. The cover 81 is attached to the base member 52. The cover 81 is secured to the base member 52 with a fastener 81A such as a screw. The cover 81 at least partially covers the input part 78 in a cover attachment state where the cover 81 is attached to the base member 52. The cover 81 at least partially covers the electric cable CB1 in the cover attachment state. The cover 81 includes an opening 81C through which the electric cable CB1 extends. The cover 81 can be omitted from the electric device RD if needed or desired.

As seen in FIG. 2, the filter circuit WC13 is configured to communicate with an additional wired communicator of an additional electric device via the wired communication structure WS using power line communication technology. Examples of the additional electric device includes the electric devices 28, 30A, 30B, 32, 34A, and 34B and the first electric power source PS1. Power line communication (PLC) carries data on a conductor that is also used simultaneously for electric power transmission or electric power distribution to the additional electric devices. The filter circuit WC13 can also be referred to as a wired communicator circuit or circuitry WC13 in a case where the filter circuit WC13 includes a wired communication circuit. The filter circuit WC13 can be configured to transmit electricity from the electric power source PS without communicating with another device. For example, the electric device RD operates based on a wireless signal wirelessly received by at least one of the first wireless communicator WC11 and the second wireless communicator WC14. In such embodiments, the wired communication circuit can be omitted from the filter circuit WC13.

For example, the wired communication structure WS includes a ground line and a voltage line that are detachably connected to a serial bus that is formed by communication interfaces. In the present embodiment, the filter circuit WC13 is configured to communicate with additional wired communicators of the additional electric devices through the voltage line using the PLC technology. The filter circuit WC13 is configured to superimpose signals on a power source voltage applied from the first electric power source PS1 to the wired communication structure WS. The filter circuit WC13 is configured to receive a signal from the electronic controller EC and is configured to superimpose the signal on the power source voltage. The filter circuit WC13 is configured to separate, from the power source voltage, signals superimposed on the power source voltage of the wired communication structure WS. The filter circuit WC13 is electrically connected to the electronic controller EC to transmit, to the electronic controller EC, signals separated from the power source voltage. The filter circuit WC13 can be omitted from the electric device RD in a case where the input part 78 merely receives electricity which does not include data or signals.

In the present embodiment, the communicator WC1 is a separate member from the electronic controller EC. However, the communicator WC1 can be integrally provided with the electronic controller EC as a one-piece unitary member if needed or desired. The hardware construction of the electric device RD is not limited to the illustrated embodiment.

As seen in FIG. 2, the electric device RD of the human-powered vehicle 10 comprises a sensor 82. The sensor 82 includes at least one of a vibration sensor, an acceleration sensor, and a motion sensor. In the present embodiment, the sensor 82 includes an acceleration sensor. The sensor 82 is configured to sense acceleration applied to the electric device RD. The electronic controller EC is electrically connected to the sensor 82 to receive acceleration sensed by the sensor 82. The sensor 82 is electrically mounted on the circuit board EC3. The sensor 82 can include at least one sensor other than the sensor 82 if needed or desired.

The sensor 82 can be at least partially provided in the housing 71A of the electric device RD. The sensor 82 can be at least partially provided outside the housing 71A of the electric device RD. The sensor 82 can be at least partially provided to the electric device RD. The sensor 82 can be at least partially provided to a device other than the electric device RD.

The electric device RD of the human-powered vehicle 10 comprises a position sensor 84. The electric device RD comprises a sensor object 86. The position sensor 84 configured to sense the sensor object 86. The sensor object 86 is configured to be detected by the position sensor 84. The position sensor 84 is configured to sense a position of the sensor object 86.

The sensor object 86 is coupled to the rotational shaft 75B to rotate along with the rotational shaft 75B. The position sensor 84 is configured to sense a position of the sensor object 86. The position sensor 84 is configured to sense a rotational position of the rotational shaft 75B. The electronic controller EC is configured to obtain the rotational position of the rotational shaft 75B based on an output of the position sensor 84. Thus, the electronic controller EC is configured to obtain the position of the movable member 54. The position sensor 84 can be configured to sense a rotational position of the output shaft 75A.

In the present embodiment, the position sensor 84 includes a non-contact detector and a contact detector. For example, the position sensor 84 can include at least one of an angle sensor, an encoder, and a potentiometer. Examples of the angle sensor include a magneto-resistive sensor. Examples of the encoder include a magnetic sensor and an optical sensor. Examples of the magnetic sensor include a hall sensor. Examples of the optical sensor include a photo sensor. The sensor object 86 includes a magnetic body and a light emitter. Examples of the magnetic body includes a magnet. Examples of the light emitter include a light emitting diode (LED). However, the position sensor 84 can include a contact detector if needed or desired. The sensor object 86 can include parts other than magnetic body or the light emitter. In a case where the position sensor 84 includes a magnetic sensor, for example, the magnetic sensor is electrically mounted on the circuit board EC3, and the sensor object 86 includes a magnet coupled to the rotational shaft 75B to rotate integrally with the rotational shaft 75B.

The electronic controller EC is electrically connected to the position sensor 84 to calculate a rotational angle of the sensor object 86 based on a detection result of the position sensor 84. For example, the electronic controller EC is configured to calculate an absolute rotational angle of the sensor object 86 based on the detection result of the position sensor 84. The position sensor 84 can be electrically mounted on the circuit board EC3. The position sensor 84 can be attached to the rotational shaft 75B and electrically connected to the electronic controller EC.

The electric device RD includes a user interface SW1 configured to receive at least one user input. Examples of the user interface SW1 includes an electric switch. In the present embodiment, the user interface SW1 is configured to receive a user input U1. The electronic controller EC is electrically connected to the user interface SW1. The electronic controller EC is configured to control the communicator WC1, the actuator driver 76, or other devices based on the user input U1 received in the user interface SW1. For example, the electronic controller EC is configured to change a state of the first wireless communicator WC11 to a pairing state in response to the user input U1 received in the user interface SW1.

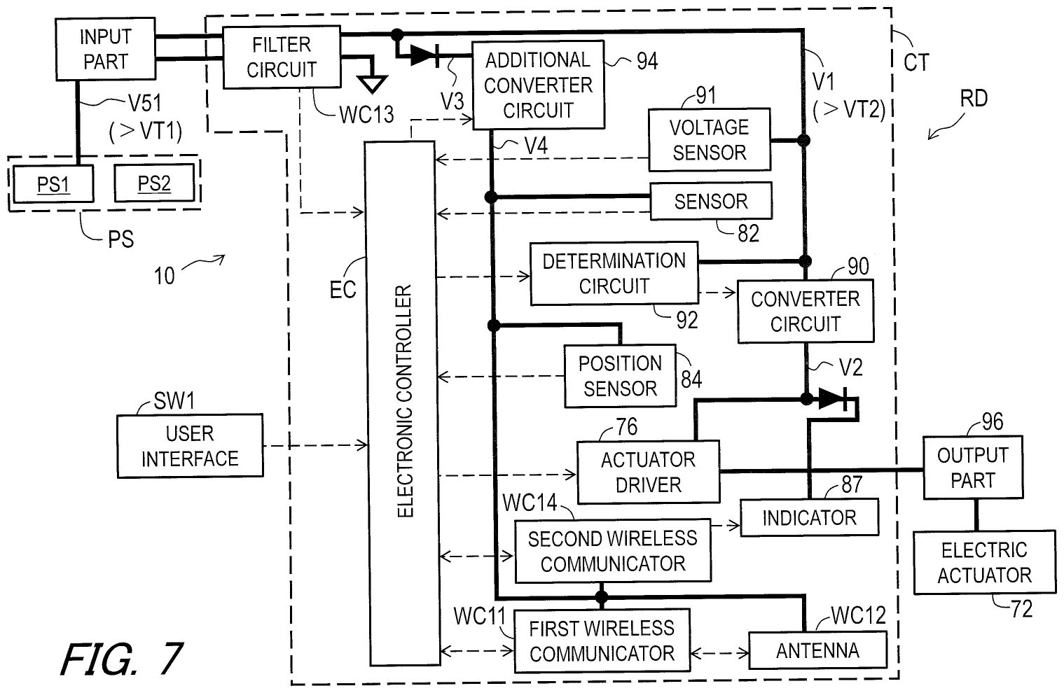

As seen in FIG. 7, the electric circuitry CT includes an indicator 87. The indicator 87 is configured to indicate information relating to the human-powered vehicle 10. The indicator 87 is configured to indicate information relating to the electric device RD. Examples of the information relating to the human-powered vehicle 10 include a remaining level of an electric power source PS, a communication state of the communicator WC1, a wireless communication state of the first wireless communicator WC11, a pairing mode of the first wireless communicator WC11, a wireless communication state of the second wireless communicator WC14, a pairing mode of the second wireless communicator WC14, and an operating mode of the electric device RD.

The indicator 87 includes a light emitter configured to emit light depending on the information relating to the human-powered vehicle 10. For example, the light emitter includes a LED. The electronic controller EC is electrically connected to the indicator 87 to control the indicator 87 based on the information relating to the human-powered vehicle 10. The indicator 87 is electrically mounted on the circuit board EC3. In the present embodiment, the electronic controller EC is electrically connected to the indicator 87 via the second wireless communicator WC14. However, the electronic controller EC can be directly connected to the indicator 87 if needed or desired.

As seen in FIG. 7, the electric device RD is configured to be electrically connected to the first electric power source PS1 via the input part 78. The electric device RD is configured to receive electricity from the first electric power source PS1 via the input part 78. The electric actuator 72 and the electric circuitry CT are configured to receive electricity from the first electric power source PS1 via the input part 78.

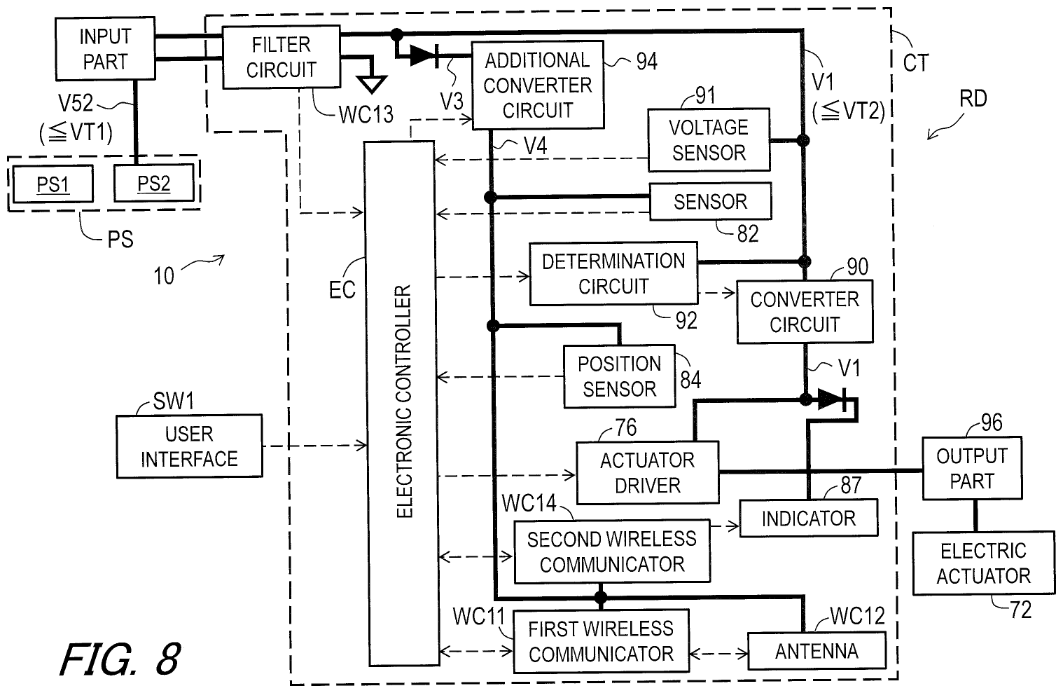

As seen in FIG. 8, the electric power source PS includes a second electric power source PS2. The second electric power source PS2 is separately provided from the first electric power source PS1. The second electric power source PS2 is provided remotely from the first electric power source PS1. However, the electric power source PS can be a single electric power source if needed or desired.

The electric device RD is configured to be electrically connected to the second electric power source PS2. The electric actuator 72 and the electric circuitry CT are configured to be electrically connected to the second electric power source PS2. The electric device RD is configured to receive electricity from the second electric power source PS2. The electric actuator 72 and the electric circuitry CT are configured to receive electricity from the second electric power source PS2. The second electric power source PS2 can include a battery. Examples of the battery include a primary battery and a secondary battery.

As seen in FIG. 1, the first electric power source PS1 is provided remotely from the electric device RD. The first electric power source PS1 is mounted to the vehicle body 22 of the human-powered vehicle 10. The first electric power source PS1 is at least partially provided in the vehicle body 22. In the present embodiment, the first electric power source PS1 is entirely provided in the vehicle body 22. However, the first electric power source PS1 can be partially provided in the vehicle body 22 if needed or desired. The first electric power source PS1 can be entirely provided outside the vehicle body 22 if needed or desired.

As seen in FIG. 3, the electric device RD further comprises a mounting part 88 to which the second electric power source PS2 is mounted. The mounting part 88 is configured to detachably and reattachably hold the second electric power source PS2. The mounting part 88 is at least partially provided to at least one of the base member 52, the movable member 54, and the link member 56. In the present embodiment, the mounting part 88 is provided to the link member 56. The mounting part 88 is provided to the first link 68. However, the mounting part 88 can be provided to at least one of the base member 52, the movable member 54, and the link member 56 if needed or desired. The mounting part 88 can be provided to the second link 70 if needed or desired.

As seen in FIGS. 7 and 8, the electric device RD is configured to be powered by the electric power source PS. The input part 78 is configured to be electrically connected to the electric power source PS. The electric device RD is configured to be powered by each of the first electric power source PS1 and the second electric power source PS2. The input part 78 is configured to be electrically connected to the electric power source PS. The input part 78 is configured to be selectively electrically connected to each of the first electric power source PS1 and the second electric power source PS2. The electric device RD is configured to be powered by only one of the first electric power source PS1 and the second electric power source PS2. In a case where the electric device RD is powered by only one of the first electric power source PS1 and the second electric power source PS2, the other of the first electric power source PS1 and the second electric power source PS2 can be omitted from the human-powered vehicle 10 and does not need to be equipped with the human-powered vehicle 10.

As seen in FIG. 2, for example, the connector port 80 of the input part 78 is a single port. The input part 78 is selectively electrically connected to the connector of the electric cable CB1 connected to the first electric power source PS1 or a connector of an electric cable CB2 connected to the second electric power source PS2. However, the input part 78 can be configured to be electrically connected to both the electric cables CB1 and CB2 if needed or desired. In such embodiments, the input part 78 includes at least two connector ports to which the electric cables CB1 and CB2 are electrically connected respectively. The electric device RD can include a circuit configured to select only one of the first electric power source PS1 and the second electric power source PS2.

The first electric power source PS1 has a first rated voltage. The second electric power source PS2 has a second rated voltage. In the present embodiment, the first rated voltage is higher than the second rated voltage. However, the first rated voltage can be lower than the second rated voltage if needed or desired.

As seen in FIG. 7, the input part 78 is configured to be electrically connected to the first electric power source PS1. The input part 78 is configured to receive electricity from the first electric power source PS1 in a state where the first electric power source PS1 is electrically connected to the input part 78. The input part 78 is configured to receive an input voltage V51 from the first electric power source PS1 in the state where the first electric power source PS1 is electrically connected to the input part 78.

As seen in FIG. 8, the input part 78 is configured to be electrically connected to the second electric power source PS2. The input part 78 is configured to receive electricity from the second electric power source PS2 in a state where the second electric power source PS2 is electrically connected to the input part 78. The input part 78 is configured to receive an input voltage V52 from the second electric power source PS2 in the state where the second electric power source PS2 is electrically connected to the input part 78.

The input voltage V51 is different from the input voltage V52. In the present embodiment, the input voltage V51 is higher than the input voltage V52. However, the input voltage V51 can be lower than the input voltage V52 if needed or desired.

As seen in FIGS. 7 and 8, the filter circuit WC13 is configured to receive the input voltage V51 or V52 through the input part 78. In a case where signals are superimposed on the input voltage V51, the filter circuit WC13 is configured to separate the signals superimposed on the input voltage V51 from the input voltage V51. In a case where signals are superimposed on the input voltage V52, the filter circuit WC13 is configured to separate the signals superimposed on the input voltage V52 from the input voltage V52. The filter circuit WC13 is configured to output the input voltage V51 or V52 as a first voltage V1.

As seen in FIG. 7, the electric circuitry CT includes a converter circuit 90. Namely, the electric device RD of the human-powered vehicle 10 comprises the converter circuit 90. The converter circuit 90 is electrically connected in series with the input part 78 and the actuator driver 76. The converter circuit 90 is configured to supply electricity received from the input part 78 to the actuator driver 76.

The converter circuit 90 is configured to convert the first voltage V1 to a second voltage V2 different from the first voltage V1. The converter circuit 90 is configured to convert the first voltage V1 to the second voltage V2 in a case where the input part 78 is connected to the first electric power source PS1. In the present embodiment, the converter circuit 90 is configured to convert the first voltage V1 to the second voltage V2 which is lower than the first voltage V1. Namely, the converter circuit 90 is configured to reduce the first voltage V1 to the second voltage V2. The converter circuit 90 includes a reduction circuit configured to reduce the first voltage V1 to the second voltage V2. However, the converter circuit 90 can include a converter circuit other than the reduction circuit if needed or desired. The converter circuit 90 can include any type of converter such as a boost converter, a buck converter, a buck-boost converter, a SEPIC converter, a Zeta converter, a Cuk converter, a flyback converter, and a forward converter.

As seen in FIG. 7, the converter circuit 90 is configured to convert the first voltage V1 to the second voltage V2 based on comparison of the input voltage V51 with a first voltage threshold VT1. The converter circuit 90 is configured to convert the first voltage V1 to the second voltage V2 in a case where the input voltage V51 applied to the input part 78 is higher than the first voltage threshold VT1.

The converter circuit 90 is configured to convert the first voltage V1 to the second voltage V2 based on comparison of the first voltage V1 with a second voltage threshold VT2. The converter circuit 90 is configured to convert the first voltage V1 to the second voltage V2 in a case where the first voltage V1 is higher than the second voltage threshold VT2.

In the present embodiment, the second voltage threshold VT2 is different from the first voltage threshold VT1. The second voltage threshold VT2 is lower than the first voltage threshold VT1 by an expected voltage drop. The first voltage V1 is substantially equal to the input voltage V51. However, the second voltage threshold VT2 can be equal to the first voltage threshold VT1 if needed or desired. The first voltage V1 can be different from the input voltage V51.

The converter circuit 90 supplies the second voltage V2 to the actuator driver 76 and the indicator 87. The actuator driver 76 supplies the second voltage V2 or a voltage which is substantially equal to the second voltage V2 to the electric actuator 72. The electric actuator 72 is powered by electricity supplied from the actuator driver 76.

The second voltage V2 is substantially equal to the rated voltage of the electric actuator 72 while the first voltage V1 is different from a rated voltage of the electric actuator 72. Thus, the electric actuator 72 can be powered by the first electric power source PS1 having the first rated voltage higher than the rated voltage of the electric actuator 72.

As seen in FIG. 8, the converter circuit 90 is configured to output the first voltage V1 without converting the first voltage V1 to the second voltage V2 in a case where the input part 78 is connected to the second electric power source PS2. The converter circuit 90 is configured to output the first voltage V1 without converting the first voltage V1 to the second voltage V2 in a case where the input voltage V52 is lower than the first voltage threshold VT1. The converter circuit 90 is configured to output the first voltage V1 without converting the first voltage V1 to the second voltage V2 in a case where the first voltage V1 is lower than the second voltage threshold VT2.

In the present embodiment, the converter circuit 90 is configured to convert the first voltage V1 to the second voltage V2 in a case where the input voltage V51 applied to the input part 78 is higher than the first voltage threshold VT1. The converter circuit 90 is configured to convert the first voltage V1 to the second voltage V2 in a case where the first voltage V1 is higher than the second voltage threshold VT2. However, the converter circuit 90 can be configured to convert the first voltage V1 to the second voltage V2 in a case where the input voltage V52 is equal to the first voltage threshold VT1 if needed or desired. The converter circuit 90 can be configured to convert the first voltage V1 to the second voltage V2 in a case where the first voltage V1 is equal to the second voltage threshold VT2 if needed or desired.

The converter circuit 90 supplies the first voltage V1 to the actuator driver 76 and the indicator 87. The actuator driver 76 supplies the first voltage V1 or a voltage which is substantially equal to the first voltage V1 to the electric actuator 72. The electric actuator 72 is powered by electricity supplied from the actuator driver 76.

The first voltage V1 is substantially equal to the rated voltage of the electric actuator 72 since the second raged voltage of the second electric power source PS2 is substantially equal to the raged voltage of the electric actuator 72. Thus, the electric actuator 72 can be powered by the second electric power source PS2.

In the present embodiment, the converter circuit 90 is integrated as a single chip. However, the converter circuit 90 can include at least two separate circuits if needed or desired. For example, the converter circuit 90 can include a first circuit configured to convert the first voltage V1 to the second voltage V2 and a second circuit configured to bypass the first circuit.

As seen in FIG. 7, the electric circuitry CT includes a voltage sensor 91. Namely, the electric device RD further comprises the voltage sensor 91. The voltage sensor 91 is electrically connected to the line connecting the input part 78 and the converter circuit 90. The voltage sensor 91 is electrically connected to the line connecting the filter circuit WC13 and the converter circuit 90. The voltage sensor 91 is configured to sense, as the first voltage V1, a voltage applied to a line connecting the input part 78 and the converter circuit 90. The voltage sensor 91 is configured to sense, as the first voltage V1, a voltage applied to a line connecting the filter circuit WC13 and the converter circuit 90. The electronic controller EC is electrically connected to the voltage sensor 91 to receive the first voltage V1 sensed by the voltage sensor 91.

As seen in FIG. 7, the electric circuitry CT includes a determination circuit 92. Namely, the electric device RD further comprises the determination circuit 92. The determination circuit 92 is configured to determine that the converter circuit 90 converts the first voltage V1 to the second voltage V2. The determination circuit 92 is configured to determine whether the converter circuit 90 converts the first voltage V1 to the second voltage V2 based on the first voltage V1. The determination circuit 92 is configured to determine whether the input part 78 is electrically connected to the first electric power source PS1 or the second electric power source PS2.

The determination circuit 92 is electrically connected to the line connecting the input part 78 and the converter circuit 90. The determination circuit 92 is electrically connected to the line connecting the filter circuit WC13 and the converter circuit 90. The determination circuit 92 is configured to sense, as the first voltage V1, the voltage applied to a line connecting the input part 78 and the converter circuit 90. The determination circuit 92 is configured to sense, as the first voltage V1, the voltage applied to a line connecting the filter circuit WC13 and the converter circuit 90. The determination circuit 92 is configured to compare the first voltage V1 with the second voltage threshold VT2. The determination circuit 92 is configured to determine whether the first voltage V1 is higher than the second voltage threshold VT2. The determination circuit 92 is configured to determine whether the first voltage V1 is higher than the second voltage threshold VT2. The first voltage V1 is substantially equal to the input voltage V51. Namely, the determination circuit 92 is configured to determine whether the input voltage V51 is higher than the first voltage threshold VT1. The determination circuit 92 is configured to determine whether the input voltage V51 is higher than to the first voltage threshold VT1.

The determination circuit 92 is configured to control the converter circuit 90 to convert the first voltage V1 to the second voltage V2 based on comparison of the first voltage V1 with the second voltage threshold VT2. Namely, the determination circuit 92 is configured to control the converter circuit 90 to convert the first voltage V1 to the second voltage V2 based on comparison of the input voltage V51 with the first voltage threshold VT1. The determination circuit 92 is configured to control the converter circuit 90 to convert the first voltage V1 to the second voltage V2 in the case where the first voltage V1 is higher than the second voltage threshold VT2. Namely, the determination circuit 92 is configured to control the converter circuit 90 to convert the first voltage V1 to the second voltage V2 in the case where the input voltage V51 is higher than to the first voltage threshold VT1.

As seen in FIG. 8, the determination circuit 92 is configured to control the converter circuit 90 to output the first voltage V1 without converting the first voltage V1 to the second voltage V2 based on comparison of the first voltage V1 with the second voltage threshold VT2. Namely, the determination circuit 92 is configured to control the converter circuit 90 to output the first voltage V1 without converting the first voltage V1 to the second voltage V2 based on comparison of the input voltage V51 with the first voltage threshold VT1. The determination circuit 92 is configured to control the converter circuit 90 to output the first voltage V1 without converting the first voltage V1 to the second voltage V2 in the case where the first voltage V1 is lower than or equal to the second voltage threshold VT2. Namely, the determination circuit 92 is configured to control the converter circuit 90 to output the first voltage V1 without converting the first voltage V1 to the second voltage V2 in the case where the input voltage V51 is lower than or equal to the first voltage threshold VT1. For example, the second voltage V2 is lower than or equal to the first voltage threshold VT1. The second voltage V2 is lower than or equal to the second voltage threshold VT2.

As seen in FIG. 7, the electric device RD further comprises an additional converter circuit 94. The additional converter circuit 94 is configured to convert a third voltage V3 to a fourth voltage V4. The additional converter circuit 94 is electrically connected in series with the input part 78 and the electronic controller EC. The fourth voltage V4 corresponds to a control voltage of a device other than the actuator driver 76. For example, the fourth voltage V4 corresponds to a control voltage of the electronic controller EC, the first wireless communicator WC11, the antenna WC12, the sensor 82, and the position sensor 84. In the present embodiment, the additional converter circuit 94 is configured to receive the third voltage V3 from the input part 78 via the filter circuit WC13 as with the converter circuit 90. Thus, the third voltage V3 is substantially equal to the first voltage V1. However, the third voltage V3 can be different from the first voltage V1 if needed or desired.

The fourth voltage V4 is different from the third voltage V3. In the present embodiment, the additional converter circuit 94 is configured to convert the third voltage V3 to the fourth voltage V4 which is lower than the third voltage V3. Namely, the additional converter circuit 94 is configured to reduce the third voltage V3 to the fourth voltage V4. The additional converter circuit 94 includes a reduction circuit configured to reduce the third voltage V3 to the fourth voltage V4. The fourth voltage V4 is lower than the second voltage V2. However, the additional converter circuit 94 can include a converter circuit other than the reduction circuit if needed or desired. The additional converter circuit 94 can include any type of converter such as a boost converter, a buck converter, a buck-boost converter, a SEPIC converter, a Zeta converter, a Cuk converter, a flyback converter, and a forward converter. The converter circuit 90 and the additional converter circuit 94 can stably supply different voltages to the actuator driver 76 and the electronic controller EC, respectively.

The electric device RD further comprises an output part 96. The output part 96 electrically connects the electric actuator 72 and the actuator driver 76 to transmit a command from the actuator driver 76 to the electric actuator 72. The output part 96 electrically connects the electric actuator 72 and the actuator driver 76 to transmit the second voltage V2 to the electric actuator 72 in a case where the converter circuit 90 converts the first voltage V1 to the second voltage V2. The output part 96 electrically connects the electric actuator 72 and the actuator driver 76 to transmit the first voltage V1 to the electric actuator 72 in a case where the converter circuit 90 outputs the first voltage V1 without converting the first voltage V1 to the second voltage V2. The actuator driver 76 is configured to generate the command to control the electric actuator 72 based on a control command transmitted from the electronic controller EC.

As seen in FIG. 5, the circuit board EC3 includes a first surface EC3A and a second surface EC3B. The second surface EC3B is provided on a reverse side of the first surface EC3A.

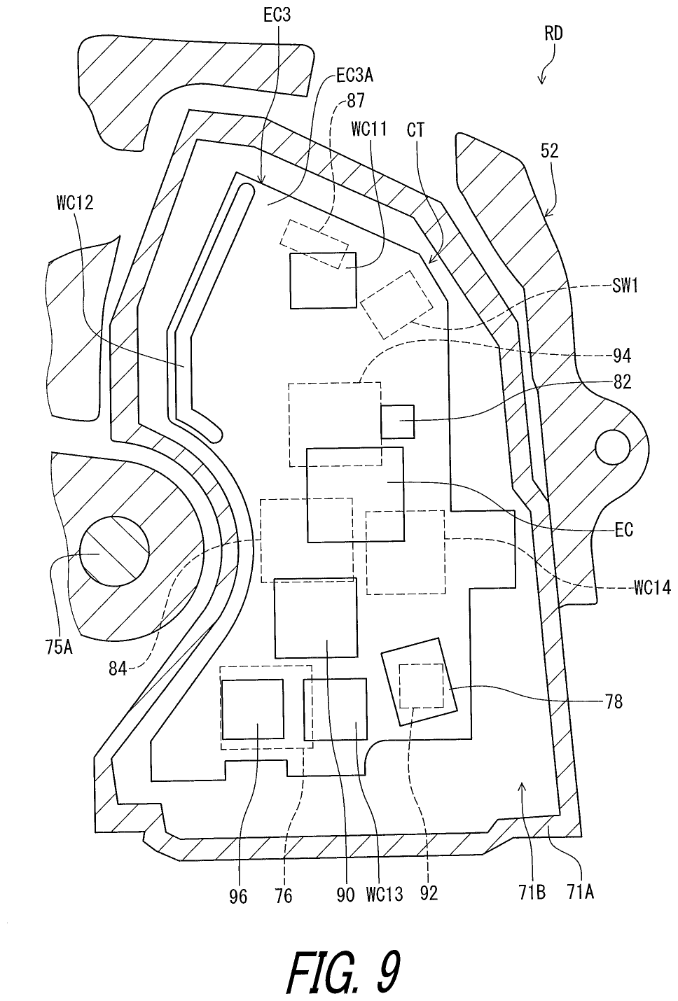

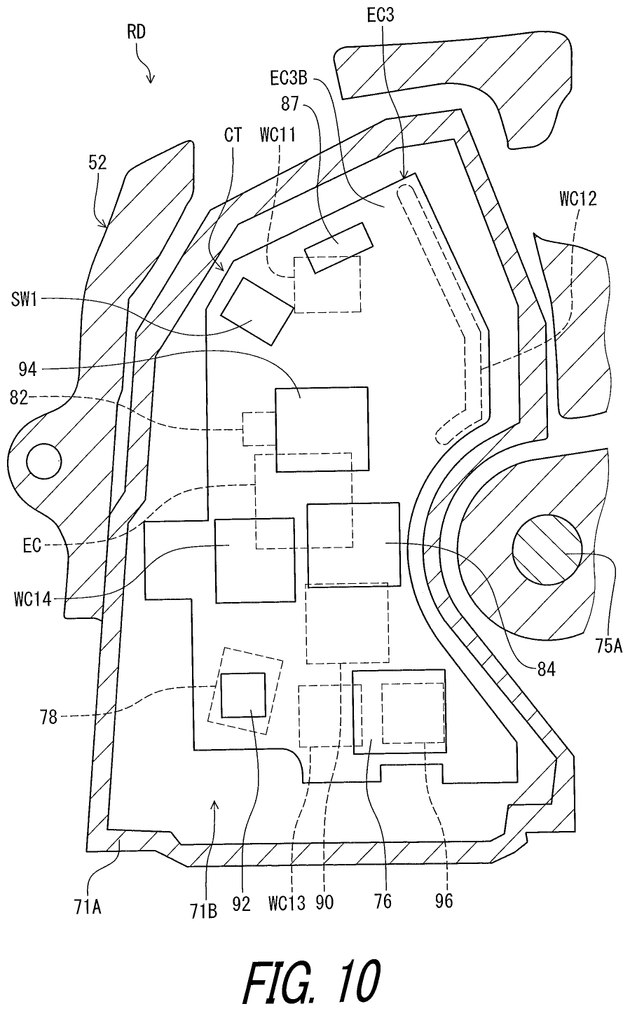

As seen in FIGS. 9 and 10, the input part 78, the converter circuit 90, and the electronic controller EC are provided on the circuit board EC3. The first wireless communicator WC11, the antenna WC12, the filter circuit WC13, the second wireless communicator WC14, the user interface SW1, the determination circuit 92, the sensor 82, the output part 96, the indicator 87, the additional converter circuit 94, the position sensor 84, and the actuator driver 76 are provided on the circuit board EC3.

As seen in FIGS. 9, the input part 78, the output part 96, and the converter circuit 90 are provided on the first surface EC3A. The electronic controller EC, the first wireless communicator WC11, the antenna WC12, the filter circuit WC13, and the sensor 82 are provided on the first surface EC3A. However, at least one of the input part 78, the output part 96, the converter circuit 90, the electronic controller EC, the first wireless communicator WC11, the antenna WC12, the filter circuit WC13, and the sensor 82 can be provided on the second surface EC3B if needed or desired.

As seen in FIGS. 10, the second wireless communicator WC14, the user interface SW1, the indicator 87, the determination circuit 92, the additional converter circuit 94, the position sensor 84, and the actuator driver 76 are provided on the second surface EC3B. However, at least one of the first wireless communicator WC11, the user interface SW1, the indicator 87, the determination circuit 92, the additional converter circuit 94, the position sensor 84, and the actuator driver 76 can be provided on the first surface EC3A if needed or desired.

As seen in FIGS. 5 and 9, the electric circuitry CT is at least partially provided to at least one of the base member 52, the movable member 54, and the link member 56. The electronic controller EC is at least partially provided to at least one of the base member 52, the movable member 54, and the link member 56. The converter circuit 90 is at least partially provided to at least one of the base member 52, the movable member 54, and the link member 56. The determination circuit 92 is at least partially provided to at least one of the base member 52, the movable member 54, and the link member 56.

In the present embodiment, the electric circuitry CT is entirely provided to the base member 52. The electronic controller EC is entirely provided to the base member 52. The converter circuit 90 is entirely provided to the base member 52. The determination circuit 92 is entirely provided to the base member 52. However, the electric circuitry CT can be at least partially provided to the base member 52, the movable member 54, and the link member 56 if needed or desired. The electronic controller EC can be at least partially provided to the base member 52, the movable member 54, and the link member 56 if needed or desired. The converter circuit 90 can be at least partially provided to the base member 52, the movable member 54, and the link member 56 if needed or desired. The determination circuit 92 can be at least partially provided to the base member 52, the movable member 54, and the link member 56 if needed or desired. The converter circuit 90 can include at least two converter circuits if needed or desired. The determination circuit 92 can include at least two determination circuits if needed or desired.

As seen in FIGS. 5 and 10, the additional converter circuit 94 is at least partially provided to at least one of the base member 52, the movable member 54, and the link member 56. The actuator driver 76 is at least partially provided to at least one of the base member 52, the movable member 54, and the link member 56.

In the present embodiment, the additional converter circuit 94 is entirely provided to the base member 52. The actuator driver 76 is entirely provided to the base member 52. However, the additional converter circuit 94 can be at least partially provided to the base member 52, the movable member 54, and the link member 56 if needed or desired. The actuator driver 76 can be at least partially provided to the base member 52, the movable member 54, and the link member 56 if needed or desired.

As seen in FIGS. 4, 5, 9, and 10, each of the electric actuator 72 and the converter circuit 90 is at least partially provided in the internal space 71B. Each of the electric actuator 72, the actuator driver 76, and the converter circuit 90 is at least partially provided in the internal space 71B. In the present embodiment, each of the electric actuator 72 and the converter circuit 90 is entirely provided in the internal space 71B. Each of the electric actuator 72, the actuator driver 76, and the converter circuit 90 is entirely provided in the internal space 71B. However, at least one of the electric actuator 72 and the converter circuit 90 can be at least partially provided in the internal space 71B if needed or desired. At least one of the electric actuator 72, the actuator driver 76, and the converter circuit 90 is at least partially provided in the internal space 71B if needed or desired.

As seen in FIGS. 9, the input part 78 is provided closer to the converter circuit 90 than the actuator driver 76. The input part 78 is provided closer to the converter circuit 90 than the actuator driver 76 as viewed in a direction perpendicular to the first surface EC3A. The input part 78 is provided closer to the converter circuit 90 than the electronic controller EC. The input part 78 is provided closer to the converter circuit 90 than the electronic controller EC as viewed in the direction perpendicular to the first surface EC3A. However, the input part 78 can be provided father from the converter circuit 90 than the actuator driver 76 if needed or desired. The input part 78 can be provided farther from the converter circuit 90 than the electronic controller EC if needed or desired.

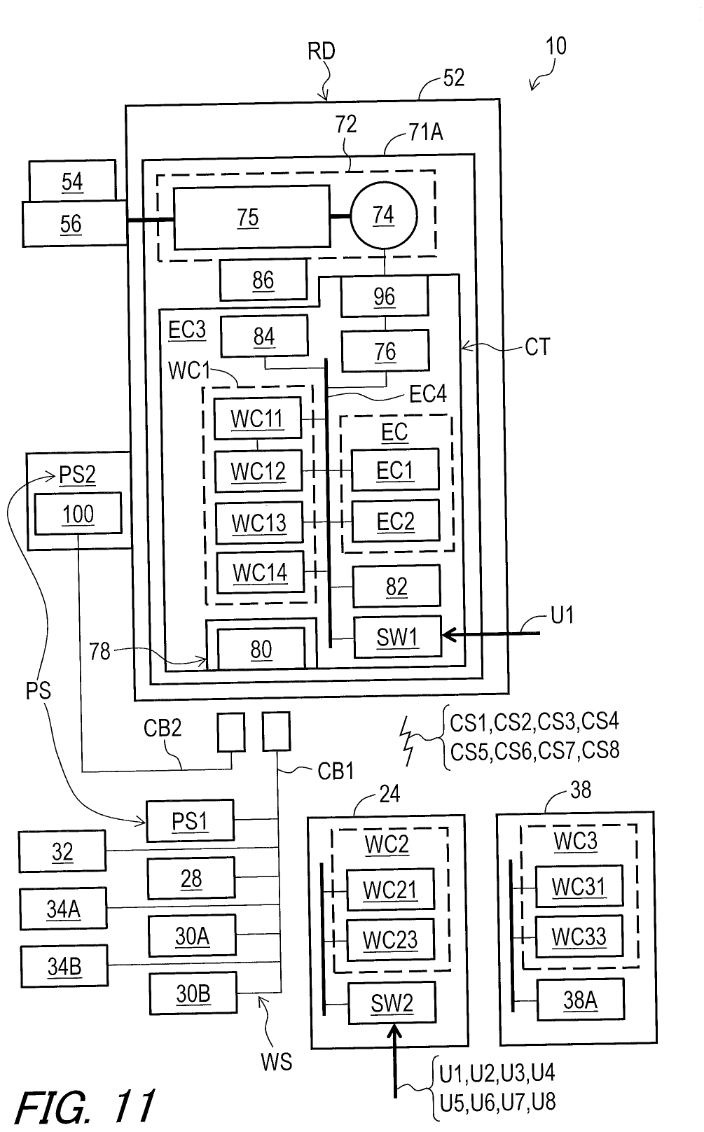

In the embodiments and modifications thereof, the second electric power source PS2 includes a battery. As seen in FIG. 11, however, the second electric power source PS2 can include a power generator 100 configured to generate electricity. The electric device RD can include a power generator 100 configured to generate electricity if needed or desired. The electric device RD can include the power generator 100 if needed or desired. The power generator 100 can be configured to convert a movement of the electric device RD to electricity. For example, the power generator 100 can be configured to convert rotation of the guide pulley 64 or the tension pulley 66 of the movable member 54 to electricity. Furthermore, the power generator 100 can be provided to at least one of hubs of the wheels 20A and 20B. The power generator 100 is configured to convert rotation of at least one of the wheels 20A and 20B into electricity.

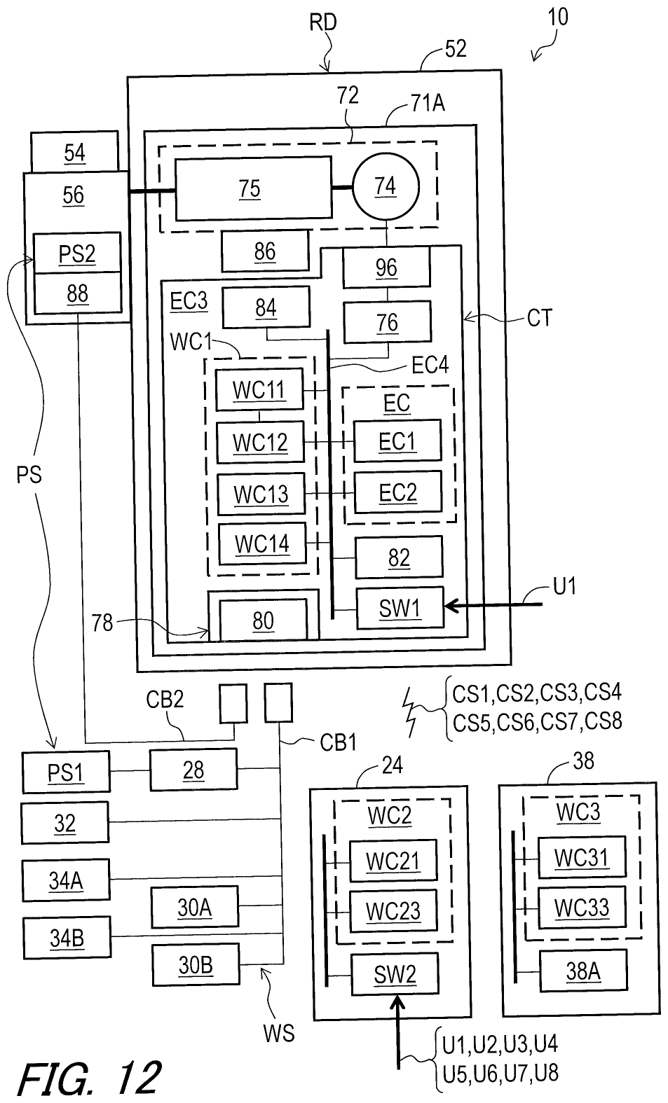

In the embodiments and modifications thereof, the electric devices RD is electrically connected directly to the first electric power source PS1. As seen in FIG. 12, however, the electric device RD can be electrically connected to the first electric power source PS1 via another device such as the drive unit 28 if needed or desired. At least one of the electric devices 30A, 30B, 32, 34A, and 34B can be electrically connected to the first electric power source PS1 via another device such as the drive unit 28 if needed or desired.

The structure of the electric device RD can be applied to each of the electric devices 30A, 30B, 32, 34A, and 34B if needed or desired. For example, at least one of the electric circuitry CT, the electric actuator 72, the input part 78, and the output part 96 can be applied to each of the electric devices 30A, 30B, 32, 34A, and 34B if needed or desired. Each of the electric devices 30A, 30B, 32, 34A, and 34B can include at least one of the electric circuitry CT, the electric actuator 72, the input part 78, and the output part 96 if needed or desired. Each of the electric devices 30A, 30B, 32, 34A, and 34B can include any one of the actuator driver 76, the input part 78, the mounting part 88, the converter circuit 90, the determination circuit 92, the additional converter circuit 94, the electronic controller EC, the first wireless communicator WC11, the antenna WC12, and the filter circuit WC13.

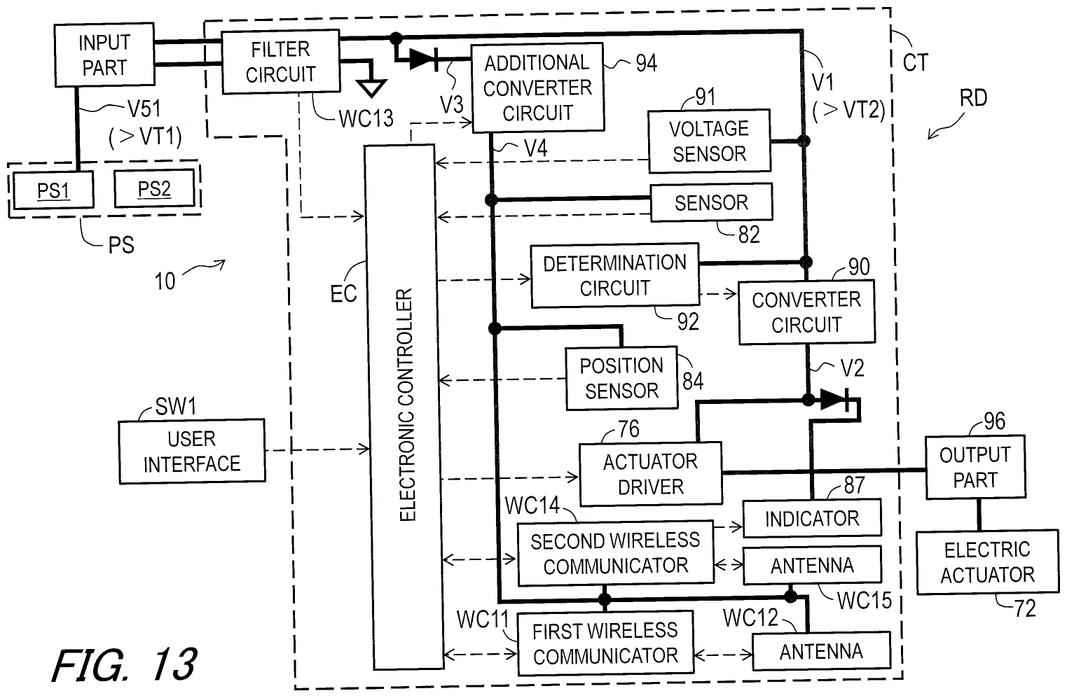

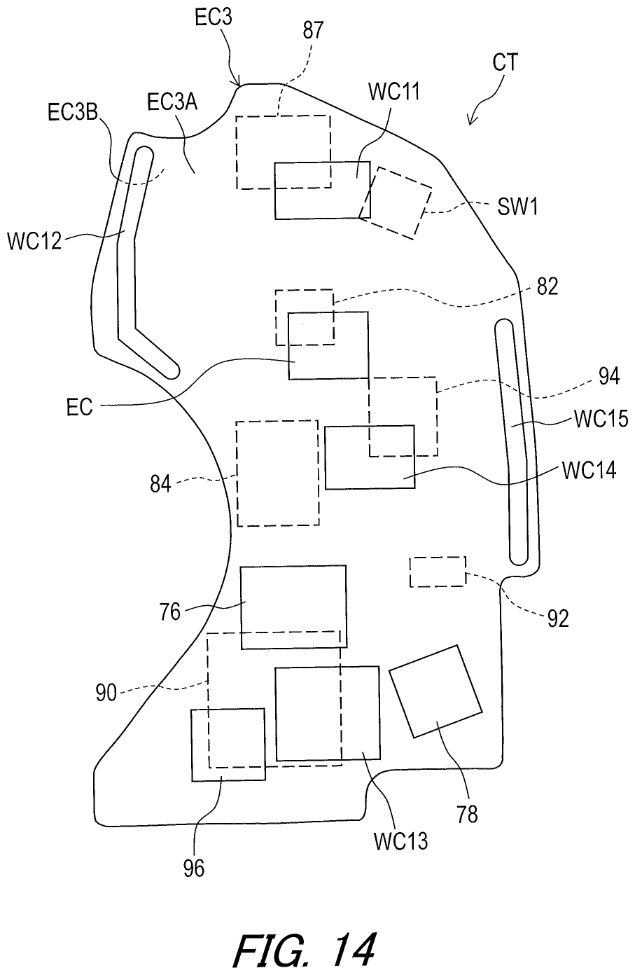

In the embodiments and modifications thereof, the second wireless communicator WC14 includes the antenna. As seen in FIGS. 13 and 14, however, the communicator WC1 can include an antenna WC15 via which the second wireless communicator WC14 wirelessly communicates with another wireless communicator if needed or desired. The antenna WC15 has substantially the same structure as the antenna WC12. The antenna WC15 is a separate member from the second wireless communicator WC14.

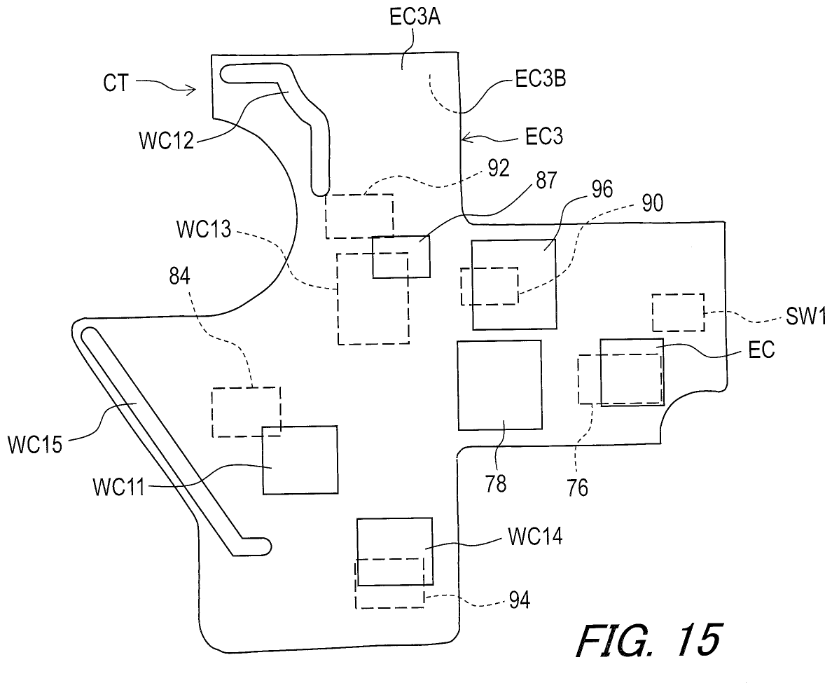

In the embodiments and modifications thereof, the input part 78 and the converter circuit 90 are provided on the same surface of the circuit board EC3. For example, the input part 78 and the converter circuit 90 are provided on the second surface EC3B of the circuit board EC3. As seen in FIGS. 14 and 15, however, the converter circuit 90 can be provided on a surface of the circuit board EC3 which is different from a surface on which the input part 78 is provided if needed or desired. In the embodiments depicted in FIGS. 14 and 15, for example, the converter circuit 90 is provided on the second surface EC3B of the circuit board EC3 while the input part 78 is provided on the first surface EC3A. The converter circuit 90 at least partially overlaps the output part 96 as viewed in the direction perpendicular to the first surface EC3A. The converter circuit 90 can be arranged to at least partially overlap the input part 78 as viewed in the direction perpendicular to the first surface EC3A if needed or desired.

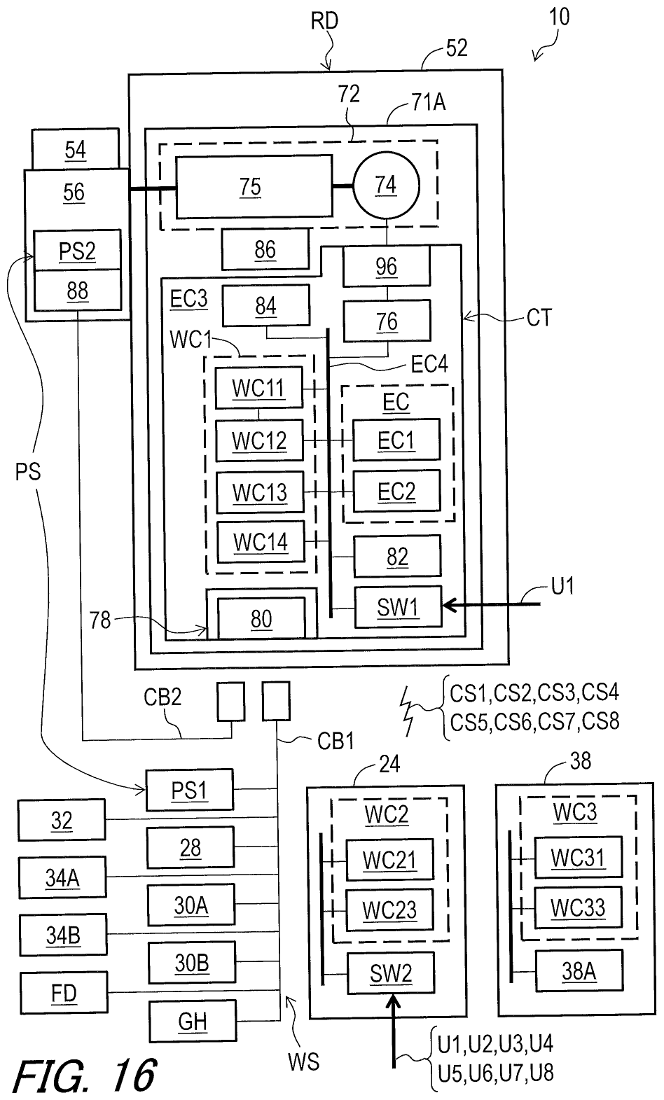

As seen in FIG. 16, the human-powered vehicle 10 can include an electric device FD provided as a front derailleur. The human-powered vehicle 10 can include an electric device GH provided as an internal-gear hub. The structure of the electric device RD can be applied to each of the electric devices FD and GH if needed or desired.

In the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “pair of,” as used herein, can encompass the configuration in which the pair of elements have different shapes or structures from each other in addition to the configuration in which the pair of elements have the same shapes or structures as each other.

The terms “a” (or “an”), “one or more” and “at least one” can be used interchangeably herein.

The phrase “at least one of” as used in this disclosure means “one or more” of a desired choice. For one example, the phrase “at least one of” as used in this disclosure means “only one single choice” or “both of two choices” if the number of its choices is two. For other example, the phrase “at least one of” as used in this disclosure means “only one single choice” or “any combination of equal to or more than two choices” if the number of its choices is equal to or more than three. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Finally, terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Obviously, numerous modifications and variations of the present invention are possible in light of the above teachings. It is therefore to be understood that within the scope of the appended claims, the invention may be practiced otherwise than as specifically described herein.

What is claimed is:

1. An electric device of a human-powered vehicle, comprising:
an input part configured to be electrically connected to an electric power source;
an electric actuator configured to move a movable member;
an actuator driver electrically connected to the electric actuator to control the electric actuator; and
a converter circuit configured to convert a first voltage to a second voltage different from the first voltage, the converter circuit being electrically connected in series with the input part and the actuator driver.

2. The electric device according to claim 1, wherein
the converter circuit is configured to convert the first voltage to the second voltage which is lower than the first voltage.

3. The electric device according to claim 1, wherein
the electric power source includes a first electric power source and a second electric power source, and
the input part is configured to be selectively electrically connected to the first electric power source and the second electric power source.

4. The electric device according to claim 3, wherein
the converter circuit is configured to convert the first voltage to the second voltage in a case where the input part is connected to the first electric power source.

5. The electric device according to claim 4, wherein
the converter circuit is configured to output the first voltage without converting the first voltage to the second voltage in a case where the input part is connected to the second electric power source.

6. The electric device according to claim 1, wherein
the converter circuit is configured to convert the first voltage to the second voltage in a case where an input voltage applied to the input part is higher than a first voltage threshold.

7. The electric device according to claim 6, wherein
the converter circuit is configured to output the first voltage without converting the first voltage to the second voltage in a case where the input voltage is lower than the first voltage threshold.

8. The electric device according to claim 6, wherein
the converter circuit is configured to convert the first voltage to the second voltage based on comparison of the input voltage with the first voltage threshold.

9. The electric device according to claim 1, wherein
the converter circuit is configured to convert the first voltage to the second voltage in a case where the first voltage is higher than a second voltage threshold.

10. The electric device according to claim 9, wherein
the converter circuit is configured to output the first voltage without converting the first voltage to the second voltage in a case where the first voltage is lower than the second voltage threshold.

11. The electric device according to claim 9, wherein
the converter circuit is configured to convert the first voltage to the second voltage based on comparison of the first voltage with the second voltage threshold.

12. The electric device according to claim 1, further comprising
a determination circuit configured to determine that the converter circuit converts the first voltage to the second voltage.

13. The electric device according to claim 3, wherein
the input part is configured to be electrically connected to the first electric power source provided remotely from the electric device.

14. The electric device according to claim 3, wherein
the input part is configured to be electrically connected to the first electric power source mounted to a vehicle body of the human-powered vehicle.

15. The electric device according to claim 3, wherein
the input part is configured to be electrically connected to the second electric power source including a power generator configured to generate electricity.

16. The electric device according to claim 3, further comprising
a mounting part to which the second electric power source is mounted.

17. The electric device according to claim 1, further comprising
a housing includes an internal space, and
each of the electric actuator and the converter circuit is at least partially provided in the internal space.

18. The electric device according to claim 1, wherein
the input part is provided closer to the converter circuit than the actuator driver.

19. The electric device according to claim 1, further comprising
an electronic controller electrically connected to the actuator driver to control the electric actuator via the actuator driver.

20. The electric device according to claim 19, further comprising
an additional converter circuit configured to convert a third voltage to a fourth voltage, the additional converter circuit being electrically connected in series with the input part and the electronic controller.

21. The electric device according to claim 19, wherein
the input part is provided closer to the converter circuit than the electronic controller.

22. The electric device according to claim 19, further comprising
a circuit board,
the input part, the converter circuit, and the electronic controller being provided on the circuit board.

23. The electric device according to claim 1, further comprising
an output part electrically connecting the electric actuator and the actuator driver to transmit a command from the actuator driver to the electric actuator.

24. The electric device according to claim 23, further comprising
a circuit board, wherein
the circuit board includes a first surface and a second surface provided on a reverse side of the first surface, and
the input part, the output part, and the converter circuit are provided on the first surface.

25. The electric device according to claim 1, further comprising:
a base member mountable to the human-powered vehicle;
a movable member movable relative to the base member; and
a link member movably coupling the base member and the movable member.

26. The electric device according to claim 25, wherein
the converter circuit is at least partially provided to at least one of the base member, the movable member, and the link member.
